(19) United States
(12) Patent Application Publication
(10) Pub. No.: US 2025/0305531 A1
(43) Pub. Date: Oct. 2, 2025

(54) LOCKING ASSEMBLY FOR A WEAR MEMBER ASSEMBLY

(71) Applicant: Hensley Industries, Inc., Dallas, TX (US)

(72) Inventors: David M. Hymas, Addison, TX (US); Omar A. Qutu, Richardson, TX (US); Venkata Prakash Vegunta, Flower Mound, TX (US)

(21) Appl. No.: 19/085,907

(22) Filed: Mar. 20, 2025

Related U.S. Application Data
(60) Provisional application No. 63/570,469, filed on Mar. 27, 2024.

(51) Int. Cl. F16B 21/02; E02F 9/28; F16B 21/06

(52) U.S. Cl. CPC F16B 21/02; E02F 9/2883; F16B 21/065

(57) ABSTRACT

Some embodiments of the present disclosure may include a locking pin assembly that includes a pin and a lock. The pin may include a shaft and a first flange projecting outward from the shaft and comprising a first cavity. The lock may be disposed within the first cavity of the first flange, and the lock may include a locking tab and a compressible foot. The compressible foot may be disposed within the first cavity such that the locking tab extends outward from the first flange.

### PRIORITY

This application claims the benefit of the filing date of U.S. Provisional Application 63/570,469, filed Mar. 27, 2024 and titled “Wear Member Assembly for a Material Displacement Apparatus,” the entirety of which is incorporated herein by reference.

### TECHNICAL FIELD

This disclosure is generally directed to an improved wear member assembly for use on a material displacement apparatus. The wear member assembly may be affixed to a surface of a bucket to prevent wear of the bucket.

### BACKGROUND

Material displacement apparatuses, such as excavating buckets found on construction, mining, and other earth moving or ground engaging equipment, are used to move or displace various kinds of material. However, during use the material displacement apparatus comes into abrasive, wearing contact with the earth or other material being displaced, causing the equipment to wear. Thus, material displacement apparatuses often have assemblies affixed to the surface of the bucket that improve their working life-span. These assemblies may wear before the bucket, and may be partially or entirely replaceable such that part or all of the assembly can be replaced after it is worn. Thus, these assemblies can reduce wear of the bucket itself, which may be more expensive to replace.

### SUMMARY

These assemblies may include a weld base that is welded or otherwise affixed to the surface of the bucket, a wear member that is placed on or over the weld base, and a locking pin assembly that couples the wear member to the weld base. The wear member and locking pin assembly may be removeable from the weld base so that the wear member and/or locking pin assembly can be replaced when they are worn during use. To improve functioning of the material displacement apparatus as a whole, the wear member assemblies may be shaped to improve the operability and longevity of the wear member assembly and the surface of the bucket.

One or more embodiments of the present disclosure may include a wear member attachable to a base of a material displacement apparatus. The wear member may include a top wear surface, a bottom surface opposite the top wear surface, a first lateral side, a second lateral side opposite the first lateral side, a first rib, and an opening. The first rib may project away from the bottom surface, wherein the first rib extends between the first lateral side and the second lateral side. The first rib may include a first laterally facing surface configured to contact a corresponding laterally facing surface on the base and a first lower surface configured to contact and bear against a corresponding horizontal surface on the base. The opening extending from the top wear surface to the first lower surface of the first rib.

In some embodiments, the opening may include a first ramp. In some embodiments, a bottom of the first ramp may be aligned with the first lower surface of the first rib. In some embodiments, the wear member may also include a first end extending between the first lateral side and the second lateral side. In some embodiments, the wear member may include a second end opposite the first end and extending between the first lateral side and the second lateral side and a second rib projecting downward from the bottom surface. The second rib may extend from the first end to the second end. In some embodiments, the second rib may include a third laterally facing surface configured to contact a corresponding laterally facing surface on the base and a second lower surface configured to contact a corresponding horizontal surface on the base. In some embodiments, the first rib and the second rib may intersect at an intersection. In some embodiments, the opening may be disposed at the intersection of the first rib and the second rib. In some embodiments, the first lower surface of the first rib and the second lower surface of the second rib may be aligned in a common plane. In some embodiments, the first lower surface of the first rib and the second lower surface of the second rib may form a single lower surface. In some embodiments, the wear member may also include a wall projecting downward from the bottom surface, where the wall extends around at least a portion of a perimeter of the wear member.

Some embodiments of the present disclosure may include a base for stabilizing a wear member on a material displacement apparatus. The base may include a top surface, a bottom surface, a first boss, and an opening extending from the top surface to the bottom surface. The first boss may project from the top surface and may include a first laterally facing surface. The first laterally facing surface is configured to contact a corresponding laterally facing surface on the wear member and may face toward a center of the base.

In some embodiments, the opening may include a first ramp. In some embodiments, the opening may include a pocket disposed proximate to and spaced from a bottom of the first ramp. In some embodiments, the opening may include a ridge disposed between the bottom of the first ramp and the pocket. In some embodiments, the opening also includes a recess disposed adjacent the pocket. The walls of the recess may be configured to contact a locking pin assembly. In some embodiments, the wear member may also include a second boss projecting upward from the top surface. The second boss may include a second laterally facing surface, where the second laterally facing surface is configured to contact a corresponding laterally facing surface on a wear member. The second laterally facing surface may face a center of the base. In some embodiments, the first boss may be disposed on a first corner of the top surface and the second boss may be disposed on a second corner of the top surface. In some embodiments, a perimeter of the base may be octagonally shaped or rectangularly shaped.

Some embodiments of the present disclosure may include a locking pin assembly. The locking assembly may include a pin including a shaft and a first flange projecting outward from the shaft. The first flange may also have a first cavity. The locking assembly may also include a lock disposed within the first cavity of the first flange. The lock may include a locking tab and a compressible foot. The compressible foot may be disposed within the first cavity such that the locking tab extends outward from the first flange.

In some embodiments, the first flange may also include a top ramp. In some embodiments, the first flange may also include a bottom ramp. In some embodiments, the pin may include a second flange projecting outward from the shaft and including a second cavity. In some embodiments, the first and the second flanges extend only partially circumferentially about the shaft and the second flange may be disposed on the shaft opposite the first flange. In some embodiments, the pin also includes a head disposed at a top of the shaft. In some embodiments, a diameter of the head may be larger than a diameter of the shaft. In some embodiments, the head may include a tool engagement feature, where the tool engagement feature is sunken with respect to an top surface of the head. In some embodiments, the locking pin assembly may also include a second flange and a third flange. In some embodiments, the locking pin assembly may also include a fourth flange. The first flange, second flange, third flange, and fourth flange may each have the same structure.

Some embodiments of the present disclosure may include a wear member assembly attachable to a base on a material displacement apparatus. The wear member assembly may include a base, a wear member, and a locking pin assembly. The base may have a base top surface, a base bottom surface, and a boss projecting upward from the base top surface. The boss may have a base laterally facing surface facing a center of the base. The base may also have a base opening extending from the base top surface to the base bottom surface. The wear member assembly may include a wear member and a pin. The wear member may include a top wear surface, a bottom surface, a first lateral side, a second lateral side opposite the first lateral side, a rib, and a wear member opening. The rib may project downward from the bottom surface and may extend from the first lateral side to the second lateral side. The rib may include a wear member laterally facing surface, and a lower surface. The wear member opening may extend from the top wear surface to the lower surface of the rib. The locking pin assembly may include a pin and a lock. The pin may include a shaft and a first flange projecting outward from the shaft. The flange may have a cavity. The lock may be disposed within the cavity of the first flange. The lock may include a locking tab and a compressible foot. The compressible foot may be disposed within the cavity such that the locking tab extends outward from the first flange. The laterally facing surface of the rib may be configured to contact the base laterally facing surface of the boss and the lower surface of the rib of the wear member may be configured to contact the base top surface. The wear member opening may be alignable with the base opening. The locking pin assembly may be disposed in the wear member opening and the base opening.

In some embodiments, the wear member opening may include a first ramp and the base opening may include a second ramp. In some embodiments, the first ramp and the second ramp may be alignable in use such that the first ramp and the second ramp form a single ramp. In some embodiments, the base opening may also include a pocket, wherein the locking tab of the locking pin assembly is disposed in the pocket. In some embodiments, an upper surface of the boss may be spaced from first bottom surface of the wear member. In some embodiments, the wear member also includes a wall projecting downward from the wear member bottom surface. The wall may extend around at least a portion of a perimeter of the wear member. In some embodiments, the wall of the wear member may be spaced from a perimeter of a base and one or more outer surfaces of the boss. Some embodiments of the present disclosure may include a method of assembling a wear member to a working implement. The method may include the step of placing the wear member on a base of the working implement by contacting a first laterally facing surface of a rib of the wear member against a second laterally facing surface of a boss of the base and contacting an inner surface of the rib of the wear member against a second top surface of the base and aligning a first opening of the wear member with a second opening of the base. The method may also include inserting a locking pin assembly into the first opening of the wear member. The locking pin assembly may include a pin having a shaft and a first flange projecting outward from the shaft and comprising a cavity and a lock disposed within the cavity of the first flange. The method may also include rotating the locking pin assembly such that the locking pin assembly moves into the second opening of the base and secures the wear member to the base.

In some embodiments, the first opening may include a first ramp and the second opening may include a second ramp. In some embodiments, the first ramp and the second ramp may be aligned such that the first ramp and the second ramp form a single ramp. In some embodiments, the second opening may also include a pocket shaped to fit a locking tab of the locking pin assembly. In some embodiments, the first flange of the pin of the locking pin assembly may also include a bottom ramp. In some embodiments, the step of rotating the locking pin assembly may include sliding the bottom ramp along the first ramp of the first opening and the second ramp of the second opening. In some embodiments, the step of rotating the locking pin assembly may include compressing the lock of the locking pin assembly and decompressing the lock into the pocket of the second opening. In some embodiments, the base may also include a recess adjacent the pocket. In some embodiments, rotating the locking pin assembly may include rotating the locking pin assembly until the flange contacts a wall of the recess.

Some embodiments of the present disclosure may include a wear member attachable to a base of a material displacement apparatus. The wear member may include a top wear surface, a bottom surface opposite the top wear surface, an outer boundary defined by an outer perimeter edge, a laterally facing bearing surface, and a lock-receiving opening extending from the top wear surface through the wear member. The laterally facing bearing surface may be disposed within the outer boundary and facing toward the outer boundary, the laterally facing bearing surface structurally configured to bear against walls of the base.

In some embodiments, a rib may protrude from the bottom surface. The wear member may have a surface substantially parallel to the bottom surface and configured to act as a bearing surface on the base, where the laterally facing bearing surface forms a side surface of the rib. In some embodiments, the rib may extend between opposing sides of the outer perimeter edge. In some embodiments, the wear member may also include sidewalls defining the outer perimeter edge, the sidewalls may have a height from the bottom surface greater than a height of the base.

Some embodiments of the present disclosure may include a wear member attachable to a base of a material displacement apparatus. The wear member may include a top wear surface, a bottom surface opposite the top wear surface, a first lateral side, a second lateral side opposite the first lateral side, a first end, a second end opposite the first end, a rib projecting downward from the bottom surface, a wear member wall, and an opening extending from the top wear surface to the lower surface of the rib. The rib may extend between the first lateral side and the second lateral side. The rib may include a lower surface configured to contact a corresponding horizontal surface on the base. The wear member wall may extend downward from at least one of the first lateral side, the first end, the second lateral side, or the second end. A first vertical surface of the wear member wall may be configured to contact a corresponding vertical surface on the base.

In some embodiments, the opening may include a first tab extending inward from an opening wall. In some embodiments, a tab bottom surface of the first tab may be aligned with the lower surface of the rib. In some embodiments, the opening may include a second tab extending inward from the opening wall and radially spaced from the first tab. In some embodiments, the second tab may be axially aligned with the first tab. In some embodiments, the first tab may include a tab top surface, where the tab top surface may be angled upward from a tab outer surface of the first tab to the wall of the opening. In some embodiments, the wear member may include a corner shelf extending downward from a corner of the bottom surface. The corner shelf may include a second vertical surface configured to contact a corresponding vertical surface on the base.

Some embodiments of the present disclosure may include a base for stabilizing a wear member on a material displacement apparatus. The base may include a top surface, a bottom surface, a first boss projecting from the top surface, and an opening extending from the top surface to the bottom surface. The boss may include a first laterally facing surface configured to contact a corresponding laterally facing surface on the wear member. The first laterally facing surface may face away from a centerline of the base.

In some embodiments, the opening may include a first tab extending inward from a wall of the opening. In some embodiments, a tab top surface of the first tab may be aligned with the top surface of the base. In some embodiments, the opening may include a second tab extending inward from a wall of the opening and radially spaced from the first tab. In some embodiments, the second tab may be axially aligned with the first tab. In some embodiments, the first tab may include a tab bottom surface. The tab bottom surface may be angled downward from a tab outer surface of the first tab to the wall of the opening. In some embodiments, the first boss may also include a first portion disposed along a first lateral side of the base and a second portion disposed along a second lateral side of the base opposite the first lateral side. In some embodiments, the first boss may also include a third portion disposed along a first end of the base extending between the first lateral side and the second lateral side. In some embodiments, the first portion may be connected to the third portion via a first connecting portion and the second portion may be connected to the third portion via a second connecting portion. In some embodiments, the base may also include a second boss projecting from the top surface. The second boss may include a second laterally facing surface configured to contact a corresponding laterally facing surface on the wear member.

Some embodiments of the present disclosure may include a locking pin assembly. The locking pin assembly may include a pin. The pin may include a shaft comprising a cavity, a first upper flange projecting outward from a top portion of the shaft, and a first lower flange projecting outward from a bottom portion of the shaft. The locking pin assembly may also include a lock disposed within the cavity.

In some embodiments, the pin may also include a second upper flange radially spaced from and axially aligned with the first upper flange. In some embodiments, the pin may also include a second lower flange radially spaced from and axially aligned with the first lower flange. In some embodiment the lock may be radially aligned with and axially spaced from the first upper flange and the first lower flange. In some embodiments, the lock may include a locking tab and a biasing mechanism coupled to the locking tab. The biasing mechanism may bias the locking tab outward from the cavity.

Some embodiments of the present disclosure may include a wear member assembly attachable to a base on a material displacement apparatus. The base may have a base top surface, a base bottom surface, a boss projecting upward from the base top surface, and a base opening extending from the base top surface to the base bottom surface. The boss may include a base laterally facing surface facing a center of the base. The wear member assembly may include a wear member and a locking pin assembly. The wear member may include a top wear surface, a bottom surface, a first lateral side, a second lateral side opposite the first lateral side, a first end, a second end opposite the first end, a rib projecting downward from the bottom surface, a wear member wall, and a wear member opening extending from the top wear surface to the lower surface of the rib. The rib may extend between the first lateral side and the second lateral side. The rib may have a lower surface. The wear member wall may extend downward from at least one of the first lateral side, the first end, the second lateral side, or the second end. A vertical surface of the wear member wall may be configured to contact a corresponding vertical surface on the base. The locking pin assembly may include a pin. The pin may include a shaft having a cavity, a first upper flange projecting outward from a top portion of the shaft, and a first lower flange projecting outward from a bottom portion of the shaft. The locking pin assembly may also include a lock disposed within the cavity. The vertical surface of the wear member wall may be configured to contact the base laterally facing surface of the boss and the lower surface of the rib of the wear member may be configured to contact the base top surface. The wear member opening may be alignable with the base opening. The locking pin assembly may be disposed in the wear member opening and the base opening.

In some embodiments, the wear member opening may include first tab and the base opening comprises a second tab. In some embodiments, the first tab and the second tab may be aligned.

Some embodiments of the present disclosure may include a method of assembling a wear member to a working implement. The method may include the step of placing the wear member on a base of the working implement by contacting a vertical surface of a wear member wall of the wear member against a laterally facing surface of a boss of the base, and contacting a lower surface of a rib of the wear member against a second top surface of the base and by aligning a first opening of the wear member with a second opening of the base. The method may also include inserting a locking pin assembly into the first opening of the wear member. The locking pin assembly may include a pin. The pin may include a shaft having a cavity, an upper flange projecting outward from a top portion of the shaft, and a lower flange projecting outward from a bottom portion of the shaft. The locking pin assembly may also include a lock disposed within the cavity of the shaft. The method may also include rotating the locking pin assembly such that lower flange is disposed below a base tab in the second opening.

In some embodiments, the first opening may include a wear member tab. In some embodiments, rotating the locking pin assembly further may include rotating the locking pin assembly such that the upper flange of the locking pin assembly is disposed above the wear member tab. In some embodiments, rotating the locking pin assembly may include compressing the lock of the locking pin assembly.

It is to be understood that both the foregoing general description and the following drawings and detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following.

### BRIEF DESCRIPTION OF THE DRAWINGS

The accompanying drawings illustrate implementations of the systems, devices, and methods disclosed herein and together with the description, serve to explain the principles of the present disclosure.

FIG. 1A is a perspective view of a wear runner assembly in an exploded configuration, according to one or more embodiments of the present disclosure.

FIG. 1B is a top view of a wear runner assembly, according to one or more embodiments of the present disclosure.

FIG. 2A is a perspective view of a weld base, according to one or more embodiments of the present disclosure.

FIG. 2B is a top view of a weld base, according to one or more embodiments of the present disclosure.

FIG. 2C is a bottom view of a weld base, according to one or more embodiments of the present disclosure.

FIG. 2D is a perspective view of the opening of a weld base, according to one or more embodiments of the present disclosure.

FIG. 3A is a perspective top view of a wear runner, according to one or more embodiments of the present disclosure.

FIG. 3B is a perspective bottom view of a wear runner, according to one or more embodiments of the present disclosure.

FIG. 3C is a top view of a wear runner, according to one or more embodiments of the present disclosure.

FIG. 3D is a bottom view of a wear runner, according to one or more embodiments of the present disclosure.

FIG. 3E is a side view of a wear runner, according to one or more embodiments of the present disclosure.

FIG. 3F is a top view of the opening of a wear runner, according to one or more embodiments of the present disclosure.

FIG. 4A is a perspective view of a locking pin assembly, according to one or more embodiments of the present disclosure.

FIG. 4B is a top view of a locking pin assembly, according to one or more embodiments of the present disclosure.

FIG. 4C is a bottom view of a locking pin assembly, according to one or more embodiments of the present disclosure.

FIG. 4D is a side view of a locking pin assembly, according to one or more embodiments of the present disclosure.

FIG. 4E is a perspective view of the lock of a locking pin assembly, according to one or more embodiments of the present disclosure.

FIG. 4F is a side view of the lock of a locking pin assembly, according to one or more embodiments of the present disclosure.

FIG. 5 is a flow chart illustrating a method of assembling a wear runner assembly, according to one or more embodiments of the present disclosure.

FIGS. 6A, 6B, 6C, 6D, and 6E illustrate various steps of assembling a wear runner assembly, according to one or more embodiments of the present disclosure.

FIG. 7 illustrates exploded view of a wear runner assembly, according to one or more embodiments of the present disclosure.

FIG. 8A illustrates a perspective top view of a weld base, according to one or more embodiments of the present disclosure.

FIG. 8B illustrates a bottom view of a weld base, according to one or more embodiments of the present disclosure.

FIG. 9A illustrates a perspective bottom view of a wear runner, according to one or more embodiments of the present disclosure.

FIG. 9B illustrates a top view of a wear runner, according to one or more embodiments of the present disclosure.

FIG. 10A illustrates a perspective view of a locking pin assembly, according to one or more embodiments of the present disclosure.

FIG. 10B illustrates a cross-section of a locking pin assembly along the 10-10 line shown in FIG. 10A, according to one or more embodiments of the present disclosure.

FIGS. 11A, 11B, 11C, 11D, and 11E illustrate various steps of assembling a wear runner assembly, according to one or more embodiments of the present disclosure.

FIG. 12 illustrates a weld base for use in a wear runner assembly, according to one or more embodiments of the present disclosure.

FIG. 13 illustrates a weld base for use in a wear runner assembly, according to one or more embodiments of the present disclosure.

These Figures will be better understood by reference to the following Detailed Description.

### DETAILED DESCRIPTION

For the purpose of promoting an understanding of the principles of the present disclosure, reference will now be made to the implementations illustrated in the drawings and specific language will be used to describe them. It will nevertheless be understood that no limitation of the scope of the disclosure is intended. Any alterations and further modifications to the described devices, instruments, methods, and any further application of the principles of the present disclosure are fully contemplated as would normally occur to one skilled in the art to which the disclosure relates. It is fully contemplated that the features, components, and/or steps described with respect to one or more implementations or Figures may be combined with the features, components, and/or steps described with respect to other implementations or Figures of the present disclosure. For simplicity, in some instances the same or similar reference numbers are used throughout the drawings to refer to the same or like parts.

The present disclosure is directed to an improved wear member assembly that may be attached to an implement, such as a bucket usable in various material displacement or ground-engaging applications. Although the implement is referenced herein as a bucket, it could be any implement for material displacement and ground engaging applications. In some examples, the wear member assembly is shaped and configured to provide at least partially protect the bucket from the abrasive flow of materials in and around the bucket. In addition to providing improved protection to the bucket, the wear member assembly may also be easier to use and may be less expensive than conventional systems.

The wear member assembly includes a weld base, a wear member, and a locking pin assembly. In some embodiments, the wear member may be a wear runner. The weld base is affixed to a surface of the bucket. The wear runner can be placed over the weld base, thus covering the weld base and at least partially protecting it from abrasive wear. The wear runner and weld base may have contact surfaces that may provide improved support to the coupling therebetween. In particular, the wear runner may comprise ribs that project downward from a bottom surface and the weld base may have bosses that project upward from the top surface. The ribs and bosses may fit together such that the contact surfaces are disposed along an inner portion of the wear runner and weld base rather than contact surfaces disposed along the outer portion. The ribs and bosses may bear loads in at least four directions and the ribs and top surface of the weld base may bear top loads. This arrangement may provide additional stability and support to the wear runner assembly while making it easy to install.

The locking pin assembly may be installed into aligned openings in the wear runner and weld base. The locking pin includes one or more flanges that may include a lock. The lock can be compressed as the locking pin assembly rotates, then may decompress into a pocket in the weld base, thereby locking the wear runner to the weld base. The locking pin assembly may be easy to install and remove while providing improved locking between the wear runner and weld base.

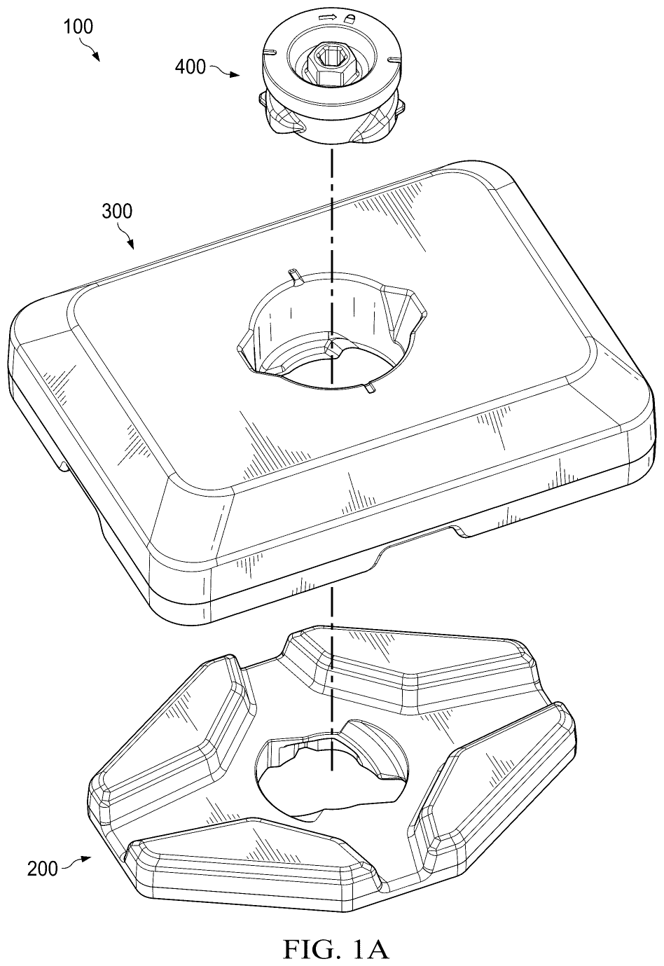

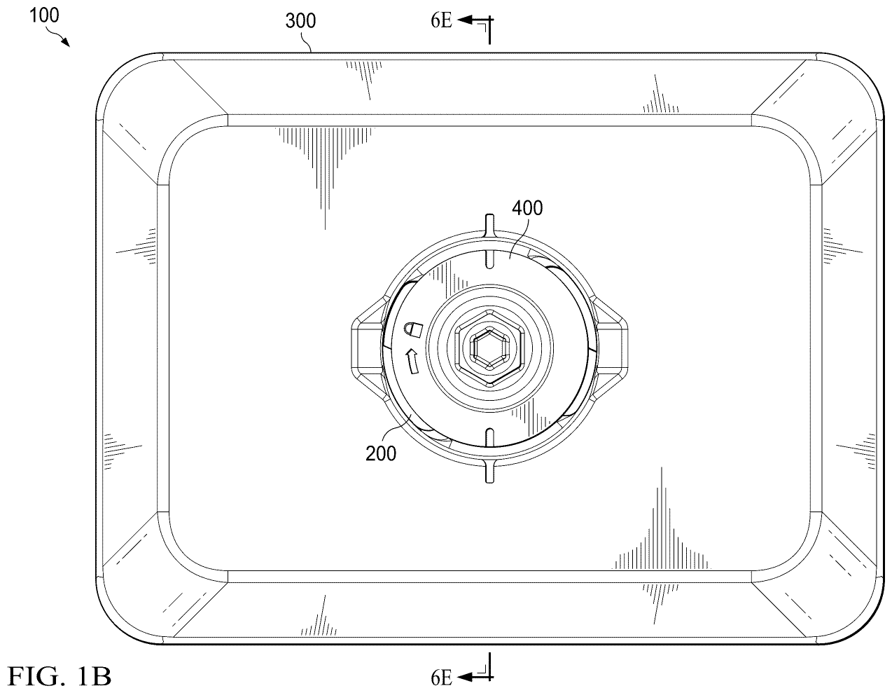

FIG. 1A is a perspective exploded view and FIG. 1B is a top view of a wear runner assembly 100 affixed to a surface of a bucket for a material displacement apparatus, according to one or more embodiments of the present disclosure. The wear runner assembly includes a weld base 200, a wear runner 300, and a locking pin assembly 400. The weld base 200 is affixed to the surface of the bucket by any suitable means. For example, the weld base 200 may be welded to the surface of the bucket. The wear runner 300 may be disposed over part or all of the weld base 200. The locking pin assembly 400 may be disposed through aligned openings in the wear runner 300 and weld base 200 thereby coupling the wear runner 300 to the weld base 200.

In some embodiments, the weld base 200, also referred to herein as a base 200, may be non-removably or permanently affixed to the surface of the bucket, such as through integral formation or welding. The wear runner 300 may be removably coupled to the weld base 200 via the locking pin assembly 400. The locking pin assembly 400 may be removed from the aligned openings, thus allowing the wear runner 300 to be removed from the weld base 200. Thus, the wear runner assembly 100 may be designed so that the wear runner 300 and/or locking pin assembly 400 are more exposed, with the wear runner bearing the brunt of the abrasive, wearing contact from the material displaced during use of the material displacement equipment. The wear runner 300 and locking pin assembly 400 may be removed and replaced when the wear runner 300 and/or locking pin assembly 400 experience sufficient wear. In this way, the wear runner assembly 100 may prevent wear of the underlying surface of the bucket.

In other embodiments, the weld base 200 may be removably affixed to the bucket. In yet other embodiments, the wear runner 300 and/or locking pin assembly 400 may be non-removably coupled to the weld base 200.

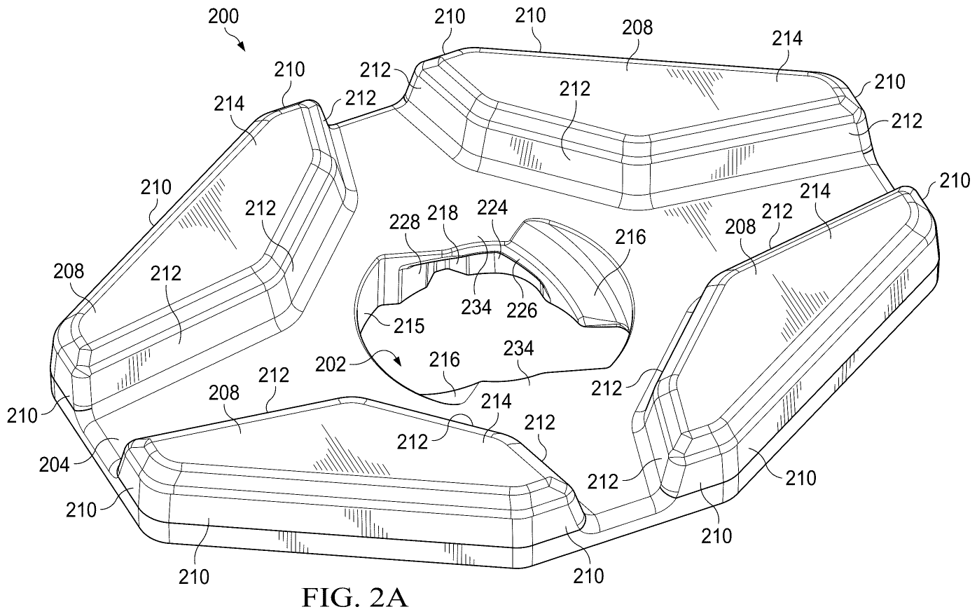

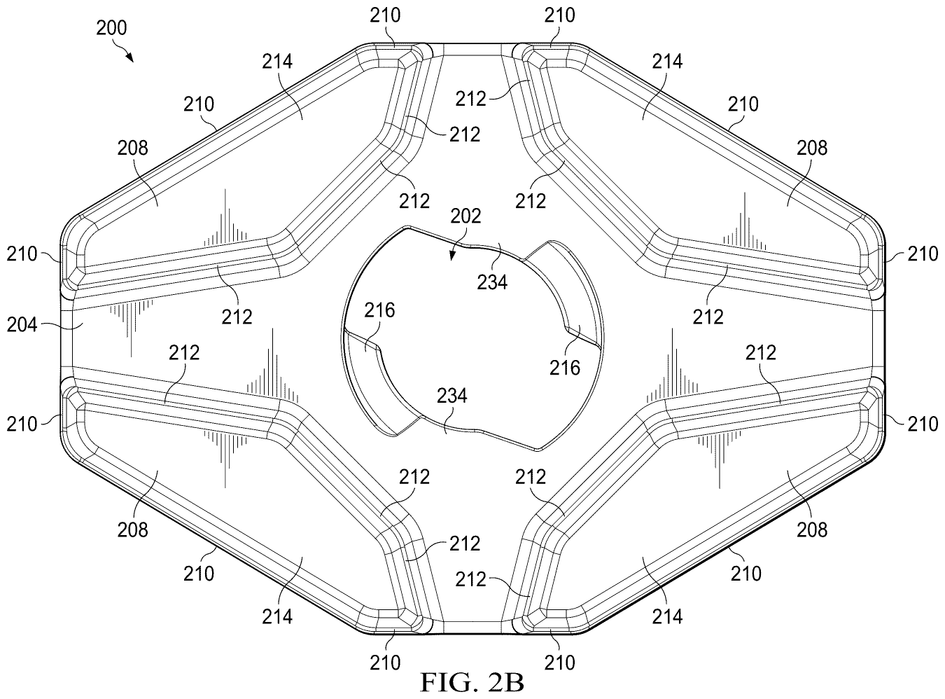

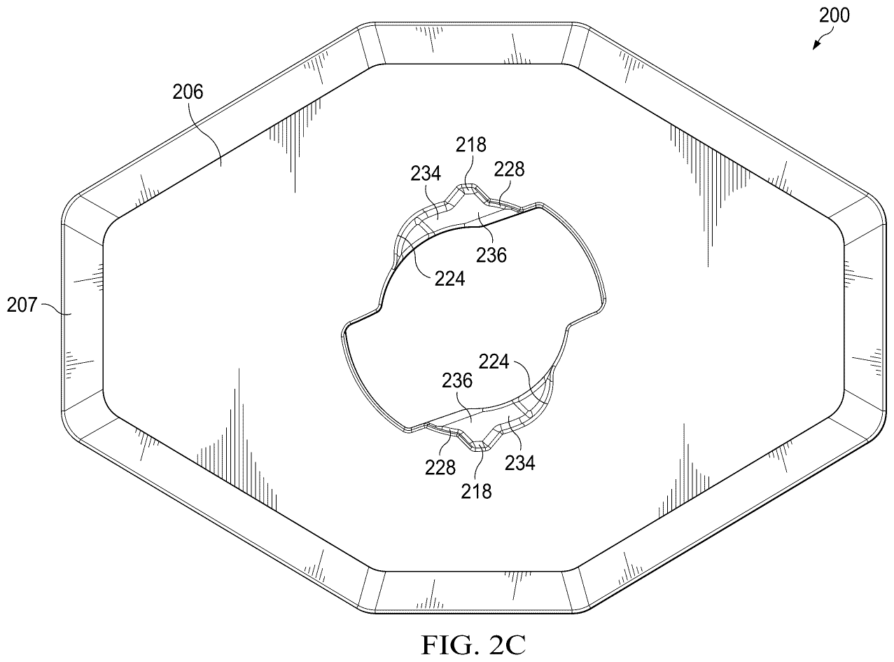

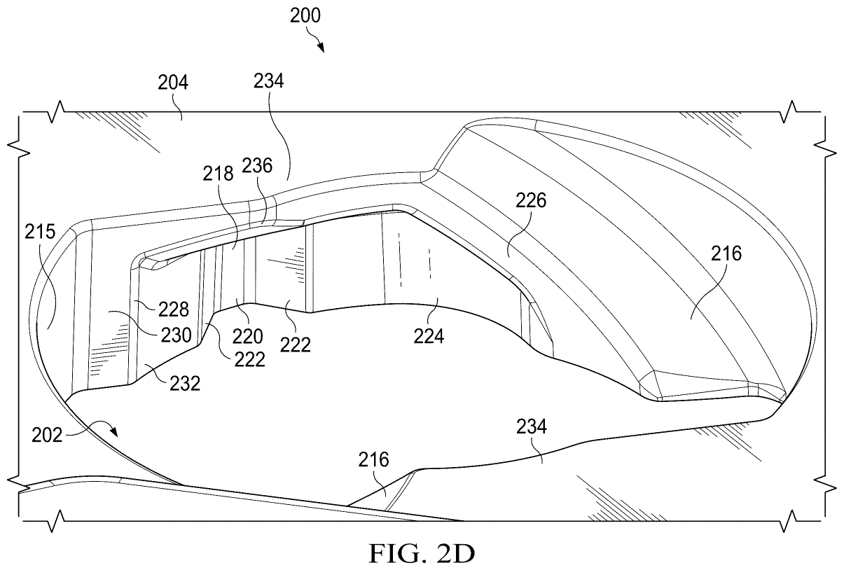

FIGS. 2A-2E illustrate various views of a weld base 200, according to one or more embodiments of the present disclosure. FIG. 2A is a perspective view, FIG. 2B is a top view and FIG. 2C is a bottom view. FIG. 2D is a perspective, zoomed-in view of the opening 202 of the weld base 200. The weld base 200 includes a top surface 204 and a bottom surface 206. The opening 202 extends from the top surface 204 to the bottom surface 206. The opening 202 may be disposed at a center of the weld base 200. However, in other embodiments, the opening 202 may be off-center.

The bottom of the weld base 200 may include one or more weld grooves 207 disposed around part or all of the perimeter of the weld base 200. The weld grooves 207 may be angled upward from the bottom surface 206. The weld grooves 207 may allow the weld base 200 to be welded to the surface of a bucket. The weld grooves 207 may also advantageously reduce the amount of material needed to form the weld base 200 decreasing the weight and lowering the cost.

In some embodiments, the perimeter of the weld base 200 may be octagonally shaped as shown in the illustrated embodiment. However, the weld base 200 may be any suitable shape. For example, the weld base 200 may be a rectangle, square, hexagon, circle, oval, or any other suitable shape. The weld base 200 may also be symmetrical. For example, when viewed from the top, the weld base 200 may be symmetrical along a horizontal axis and a vertical axis.

The weld base 200 includes one or more bosses 208 that project upwards from the top surface 204. The bosses 208 may extend along the sides or corners of the weld base 200. For example, as shown in the illustrated embodiment, a boss 208 may extend along a side of the weld base 200. The boss 208 may also extend through and past the corners defining that side. The bosses 208 may also extend inward towards a center of the weld base 200, as shown in the illustrated embodiment. In some embodiments, the bosses 208 may be arranged around the outer portion of the top surface 204 such that the bosses 208 form an inner space in the weld base 200.

There may be any suitable number of bosses 208 on the weld base 200. For example, in the illustrated embodiment, the weld base 200 may include four bosses 208 that extend along four sides. However, the weld base 200 may include 1, 2, 3, 5, 6, 7, 8, 9, or 10 bosses 208.

The bosses 208 includes one or more outer vertical surfaces 210 oriented outward from the center of the weld base 200. These outer vertical surfaces 210 may be disposed along part or all of the perimeter of the weld base 200. The bosses 208 also include one or more inner vertical surfaces 212 oriented generally inward towards a center of the weld base 200. The inner vertical surfaces 212 may be bearing surfaces configured to contact and bear or press against corresponding vertical surfaces on the wear runner 300, as described in more detail below. The bosses 208 also include an upper surface 214. The upper surface 214 of the bosses 208 is raised with respect to the top surface 204 of the weld base 200. The intersection between the outer vertical surfaces 210 and the upper surface 214 and the inner vertical surfaces 212 and the upper surface 214 may be curved such that the intersection is generally smooth.

The top surface 204 of the weld base 200 may be generally cross-shaped, as shown in the illustrated embodiment. The top surface 204 may be configured to contact a corresponding horizontal surface on the wear runner, as described in more detail below. In other embodiments, the top surface 204 may be any suitable shape. For example, the top surface 204 may be rectangular, circular, ovular, T-shaped, L-shaped, V-shaped, or any other suitable shape.

The opening 202 of the weld base 200 is shaped to fit and secure a locking pin assembly 400. The opening 202 may be defined by a wall 215 surrounding the opening 202. The opening 202 includes two ramps 216. The ramps 216 may extend from the top surface 204 of the weld base 200 to the bottom surface 206. Thus, the ramps 216 may include an inclined surface that is angled downwards towards the bottom surface 206.

There are two pockets 218 disposed in the walls of the opening 202. The pockets 218 may be shaped to fit part or all of a lock of the locking pin assembly 400, as described in more detail below. Each pocket 218 may include a back surface 220 and two angled surfaces 222 on either side of the back surface 220. There may be a recess 224 disposed next to the pocket 218. The recess 224 may extend under the ramp 216. The pocket 218 may be sunken with respect to the recess 224 and both the recess 224 and the pocket 218 may be sunken with respect to the wall 215 of the opening 202.

There is a pin shaft contact surface 226 disposed on the wall 215 of the opening 202 between the recess 224 and the ramp 216. The pin shaft contact surface 226 may be configured to contact and/or bear against the pin of the locking pin assembly 400, as described in more detail below.

The opening 202 also includes a ridge 228 disposed adjacent the pocket 218. The ridge 228 may include an angled surface 230 and a compression surface 232. The compression surface 232 is disposed adjacent the pocket 218 and the angled surface 230 is disposed adjacent the compression surface 232. The angled surface 230 may connect the wall 215 of the opening 202 with the compression surface 232. The ridge 228 may be spaced from the bottom of the other ramp 216.

The ridge 228 may be configured to contact and press against the lock of the locking pin assembly 400, compressing the lock so that it can decompress into the pocket 218, as described in more detail below. The recess 224 may prevent the locking pin assembly 400 from further rotation, maintaining the lock in the pocket 218, as described in more detail below.

The pocket 218, recess 224, and ridge 228 may be disposed at the bottom of the opening 202 such that the bottom of the pocket 218, recess 224, and ridge 228 are aligned with the bottom surface 206 of the weld base 200. Thus, there may be no surface, projection, or other part between the pocket 218, recess 224, and ridge 228 and the bottom of the weld base 200. A tab 234 may define the top of the pocket 218, recess 224, and ridge 228. The bottom surface 236 of the tab 234 may contact and bear against a flange of the locking pin assembly 400, as described in more detail below.

In some embodiments, the opening 202 only includes one ramp 216, pocket 218, recess 224, and ridge 228. In other embodiments, the opening 202 may include more than two ramps 216, pockets 218, recesses 224, and ridges 228. The number of ramps 216, pockets 218, recesses 224, and ridges 228 may be the same or may be different. For example, the opening 202 may include two ramps 216 and one pocket 218, one recess 224, and one ridge 228. Any other combination of these parts is contemplated. In some embodiments, the opening 202 may not include a ridge 228 or recess 224. In some embodiments, the opening 202 may not include ramps 216.

In some embodiments, the surface of the ramps 216 may be generally flat when considered in cross-section. In other embodiments, the surface of the ramps 216 may be curved when considered in cross-section. The ramps 216 may include more than one surface. The ramps 216 may be disposed at the same angle. In other embodiments, the ramps 216 may be disposed at different angles.

In some embodiments, the pockets 218 may only include one angled surface 222 and one back surface 220. In other embodiments, the pockets 218 may only include two angled surfaces 222 and no back surface 220. In some embodiments, the angled surfaces 222 are angled at 90 degrees relative to the surrounding surface. In some embodiments, the pockets 218 may include more than two angled surfaces 222 and more than one back surface 220. In some embodiments, the recesses 224 may include multiple surfaces. The angled surfaces 222 may be disposed at the same angle. In other embodiments, the angled surfaces 222 may be disposed at different angles. The recesses 224 may curve around the wall 215 of the opening 202. In some embodiments, the ridges 228 may only include an angled surface 230 and not a compression surface 232. In other embodiments, the ridges 228 may include more than one angled surface 230 and/or one or more compression surfaces 232.

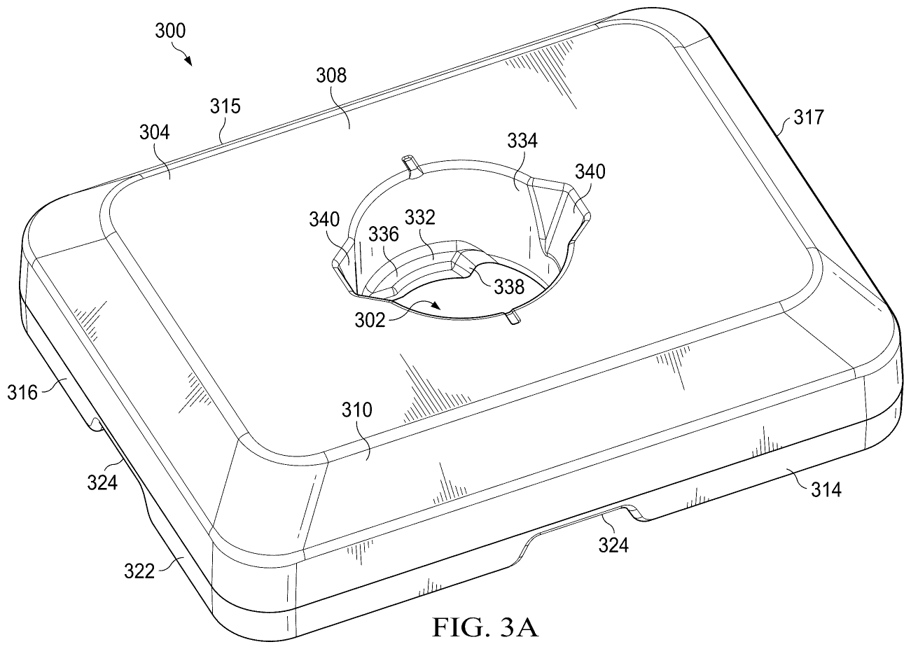

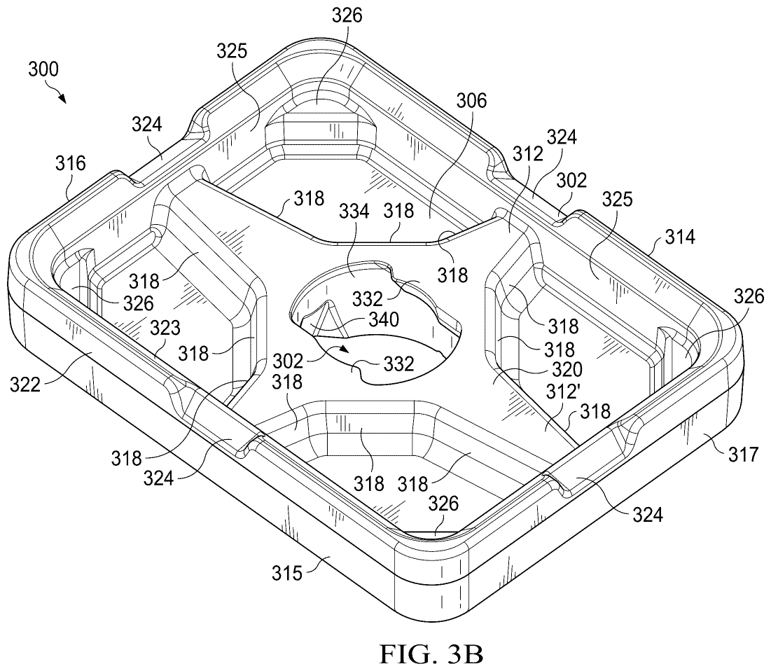

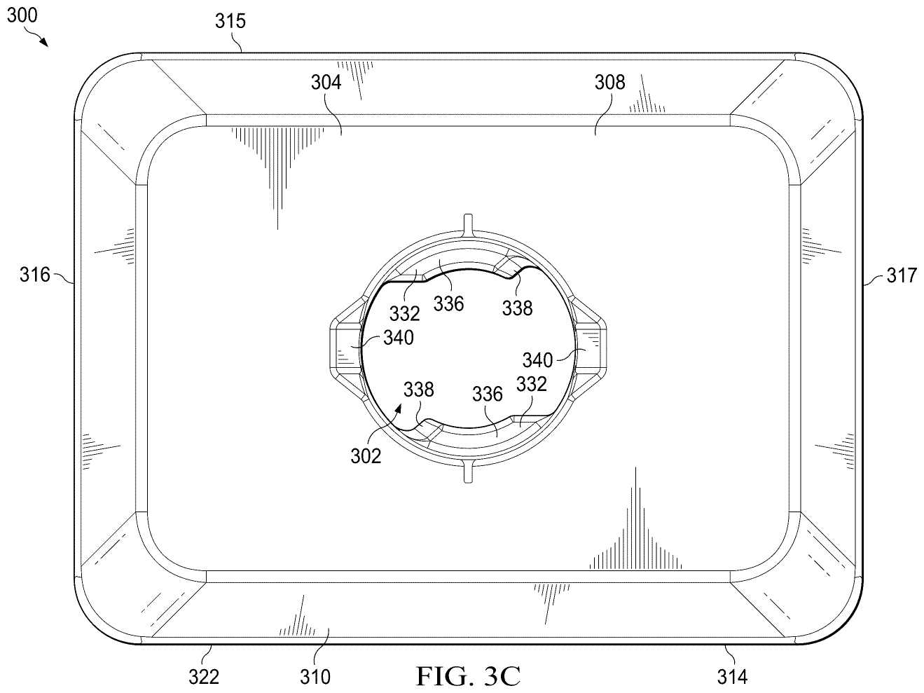

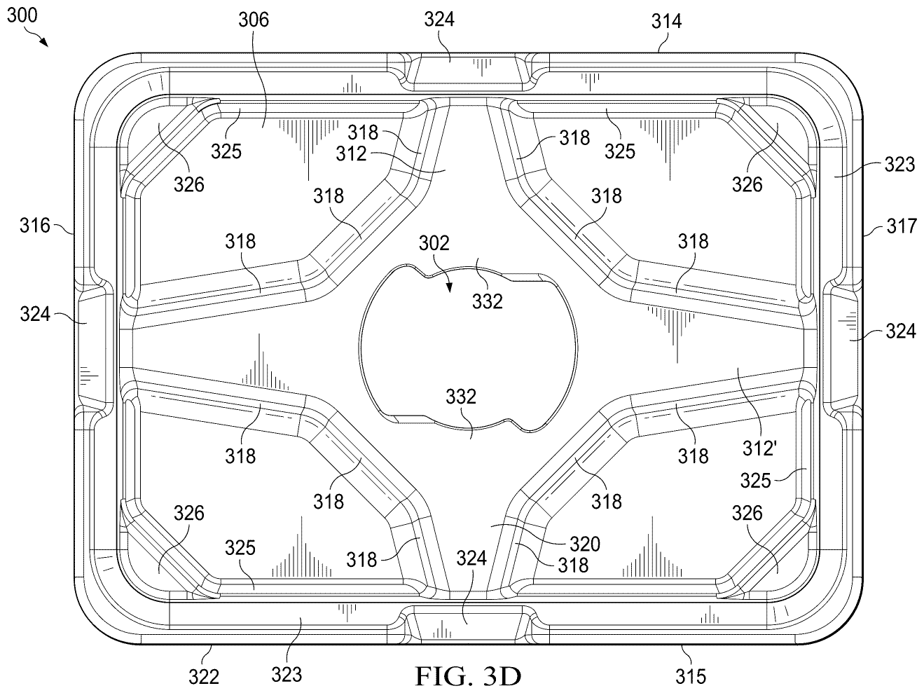

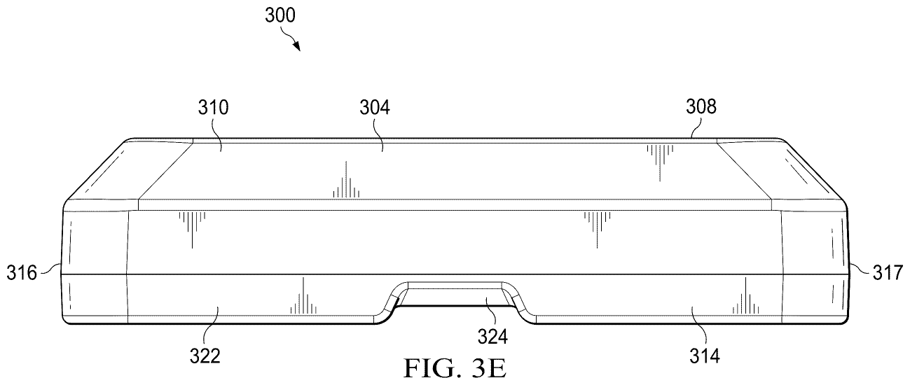

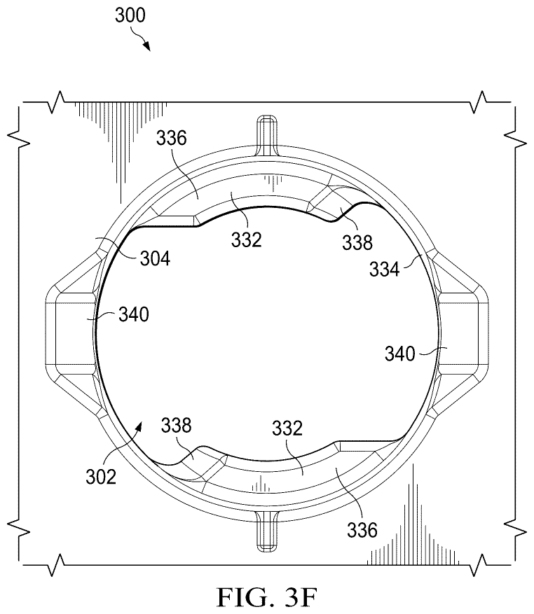

FIGS. 3A-3F illustrate various views of a wear runner 300 for use in a wear runner assembly 100, according to one or more embodiments of the present disclosure. FIG. 3A is a perspective top view, FIG. 3B is a perspective bottom view, FIG. 3C is a top view, FIG. 3D is a bottom view, and FIG. 3E is a side view of the wear runner of the wear runner 300. FIG. 3F is a top, zoomed-in view of the opening 302 of the wear runner 300. The wear runner 300 includes a top surface 304 and a bottom surface 306.

The top surface 304 may include a central flat portion 308 and an inclined outer portion 310. The inclined outer portion 310 may be inclined downward from the central flat portion 308 around the edges of the top surface 304. In some embodiments, the top surface 304 may only have a flat portion 308. In other embodiments, the top surface 304 may be partially or completely curved or may be pyramid-shaped.

In some embodiments, the perimeter of the wear runner 300 may be rectangularly shaped as shown in the illustrated embodiment. However, the wear runner 300 may be any suitable shape. For example, the wear runner 300 may be a square, hexagon, octagon, circle, oval, or any other suitable shape. The wear runner 300 may also be symmetrical. For example, when viewed from the top, the wear runner 300 may be symmetrical along a horizontal axis and a vertical axis.

The wear runner 300 may include one or more ribs 312 projecting downward from the bottom surface 306. The ribs 312 may extend along any suitable portion of the wear runner 300. In the illustrated embodiment, a first rib 312 extends from a first lateral side 314 to an opposite, second lateral side 315. A second rib 312′ extends from a first end 316 to a second end 317. The ribs 312, 312′ intersect at an intersection such that the ribs 312, 312′ are adjoined. Thus, the ribs 312, 312′ may form a single adjoined projection.

The ribs 312, 312′ may include one or more vertical surfaces 318 and a generally flat or horizontal lower surface 320. The intersection between the vertical surfaces 318 and the lower surface 320 and the vertical surfaces 318 and the bottom surface 306 may be curved such that the intersection is generally smooth. In some embodiments, the ribs 312, 312′ may form a single lower surface 320. The lower surface 320 may be configured to contact and press or bear against the top surface 204 of the weld base 200.

The vertical surfaces 318 may extend from the bottom surface 306 of the wear runner 300 to the lower surface 320. The vertical surfaces 318 may be disposed around the ribs 312, 312′ such that the face outward from the center of the wear runner 300. The vertical surfaces 318 may be configured to contact and bear against the inner vertical surfaces 212 of the bosses 208 of the weld base 200, as described in more detail below. Thus, the ribs 312, 312′ may be disposed on an inner portion of the bottom surface 306, thus creating a space around part or all of the outer portion of the bottom surface 306.

In some embodiments, the ribs 312, 312′ may form a cross shape. However, the ribs 312, 312′ may be in any suitable arrangement. For example, the ribs 312, 312′ may extend between opposite corners of the wear runner 300 and, thus, may form an X-shape. In some embodiments, the ribs 312, 312′ do not extend from side to side, or end to end. Instead, there may be a rib 312 that projects from a center of the bottom surface 306 or at a location off-center but spaced from the sides and ends. In some embodiments, the ribs 312, 312′ do not intersect or overlap. For example, both ribs 312, 312′ may extend from the first side 314 to the second side 315 or from the first end 316 to the second end 317. Thus, the ribs 312, 312′ may be spaced from each other. In some embodiments, there may only be one rib 312. In other embodiments, there may be more than two ribs 312. The intersection of the ribs 312, 312′ may be disposed at a center of the wear runner 300. However, in other cases, the intersection may be off-center.

In some embodiments, the first end 316 may be considered a front end and the second end 317 may be considered a back end. However, in some embodiments, as in the illustrated embodiment, the wear runner 300 does not have a front or back end.

The wear runner 300 may also include a wall 322 that projects downward from the bottom surface 306 along the perimeter of the wear runner 300. The wall 322 may extend partially or completely along the wear runner 300. In the illustrated embodiment, the wall 322 extends completely around the perimeter such that it extends along the first side 314, the first end 316, the second side 315, and the second end 317. There may be an inner surface 325 on the wall 322 that faces an interior of the wear runner 300. The wall 322 may include an inclined surface 323 that angles upward from the bottom of the wall 322 to the inner surface 325 of the wall 322. In some embodiments, the wall 322 may also include an inclined surface facing outward away from the center of the wear runner 300 along an outer surface of the wall 322. In some embodiments, there may be more than one wall 322. In other embodiments, there may be no wall 322.

The wall 322 may comprise one or more pry features 324. For example, the pry features 324 may be cut into the wall 322 from the bottom. In other embodiments, the pry features 324 are formed as openings, cavities or recesses in other parts of the wall 322. The pry features 324 may be disposed on at least one of the first side 314, the first end 316, the second side 315, and/or the second end 317. The pry features 324 may be shaped and configured for a tool (e.g. pry bar) to be inserted therein. After the wear runner 300 is placed over the weld base 200, a user may insert the tool into the pry feature 324 to pry the wear runner 300 off of the weld base 200. Thus, the pry feature 324 may include a ramp or inclined surface to provide additional leverage for prying the wear runner 300. In some cases, a hammer may not be needed to pry the wear runner 300 off of the weld base 200. The pry features 324 may also advantageously reduce the amount of material needed to form the wear runner 300 decreasing the weight and lowering the cost.

The wear runner 300 may also include one or more corner shelves 326. A corner shelf 326 may extend downward from the corner of the bottom surface 306 and may contact the wall 322. The corner shelf 326 may have a height shorter than that of the neighboring wall 322. In some cases, the corner shelf 326 may be spaced from the inclined surface 323 of the wall 322. Each corner shelf 326 may include a vertical surface and a generally horizontal or flat upper surface.

The opening 302 of the wear runner 300 may be disposed through the intersection of the ribs 312, 312′ such that the opening 302 extends from the top surface 304 of the wear runner 300 to the lower surface 320 of the rib 312, 312′. In some embodiments, as in the illustrated embodiment, the opening 302 may be disposed at a center of the wear runner 300. However, the opening 302 may also be disposed off-center. In some embodiments, the opening 302 may not extend through the ribs 312, 312′ and may instead extend from the top surface 304 to the bottom surface 306.

The opening 302 may include one or more tabs 332 that project inward from a wall 334 of the opening 302. In the illustrated embodiment, the opening 302 includes two tabs 332. The tabs 332 are disposed opposite from each other within the opening. Each tab 332 may have a generally flat upper surface 336 and a ramp 338. The ramp 338 may extend downward from the upper surface 336 such that the bottom of the ramp 338 is aligned with the lower surface 320 of the ribs 312, 312′ and, thus, the bottom of the opening 302. Thus, in some embodiments, the upper surface 336 of the tab 332 is spaced from the bottom of the opening 302. In some embodiments, the bottom of the ramp 338 of the tab 332 may align with the top of the ramp 216 in the opening 202 of the weld base 200 when the wear runner 300 is place over the weld base 200, as described in more detail below.

In some embodiments, the surface of the ramps 338 of the tab 332 may be generally flat. In other embodiments, the surface of the ramps 338 may be curved. The ramps 338 may include more than one surface. The ramps 338 may be disposed at the same angle. In other embodiments, the ramps 338 may be disposed at different angles. In some embodiments, the upper surfaces 336 of the tabs 332 may be horizontal. In other embodiments, the upper surfaces 336 may be angled downward. The angle of the upper surfaces 336 may be less than the angle of the ramps 338.

The opening 302 may further include one or more pin pry features 340. The pin pry features 340 may be cut into the wall 334 of the opening 302. The pin pry features 340 may be shaped and configured for a tool (e.g. pry bar) to be inserted therein. After the locking pin assembly 400 has been inserted into the wear runner 300 and weld base 200, a user may insert the tool into the pin pry feature 340 to pry the locking pin assembly 400 out of the opening 302 of the wear runner 300 and the opening 202 of the weld base 200. Thus, the pin-pry-out features 340 may have one or more angled or inclined surfaces to provide additional leverage for prying out the locking pin assembly 400.

In some embodiments, the opening 302 may only include one tab 332 or may include more than two tabs 332. In some embodiments, the tab 332 may only include a ramp 338 and may not include a flat upper surface 336, or vice versa. In some embodiments, the opening 302 may only include one pin pry feature 340 or may include more than two pin pry features 340.

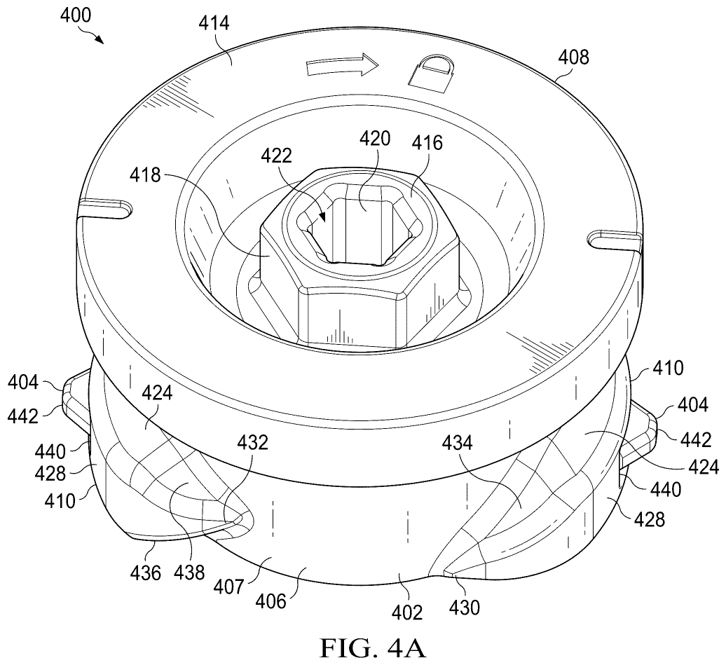

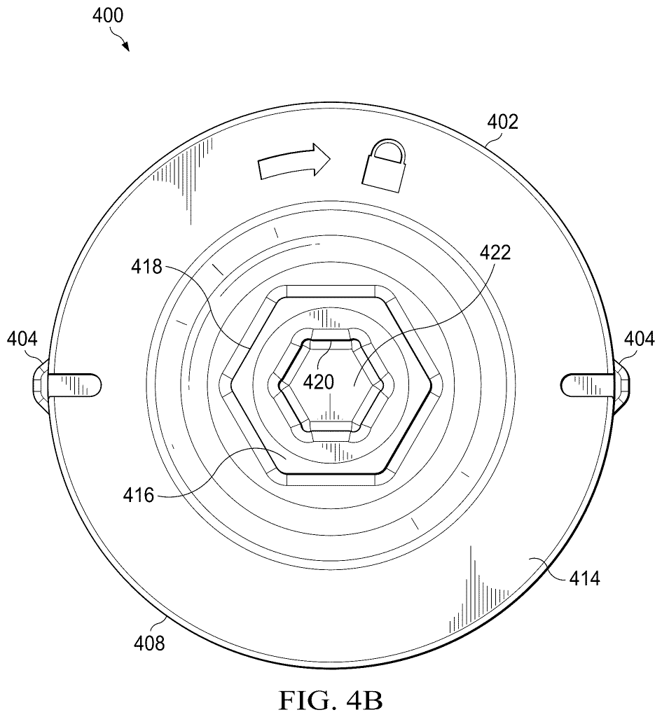

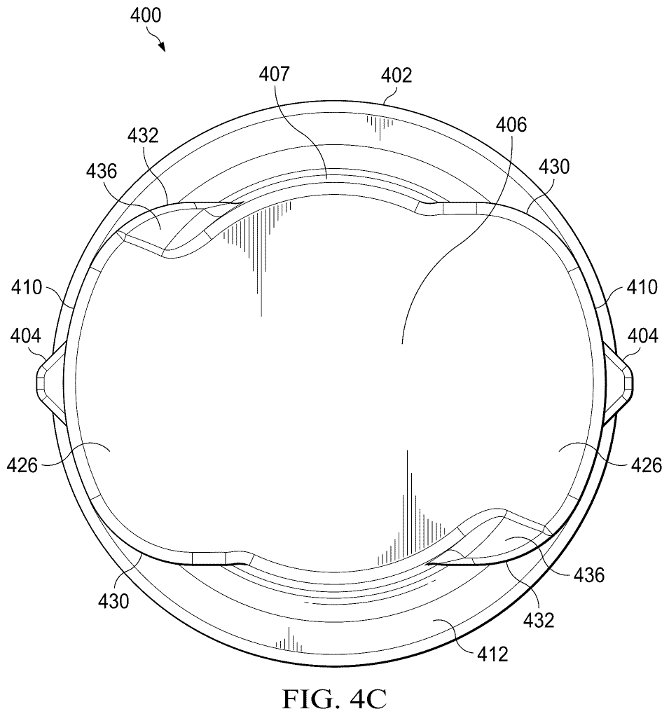

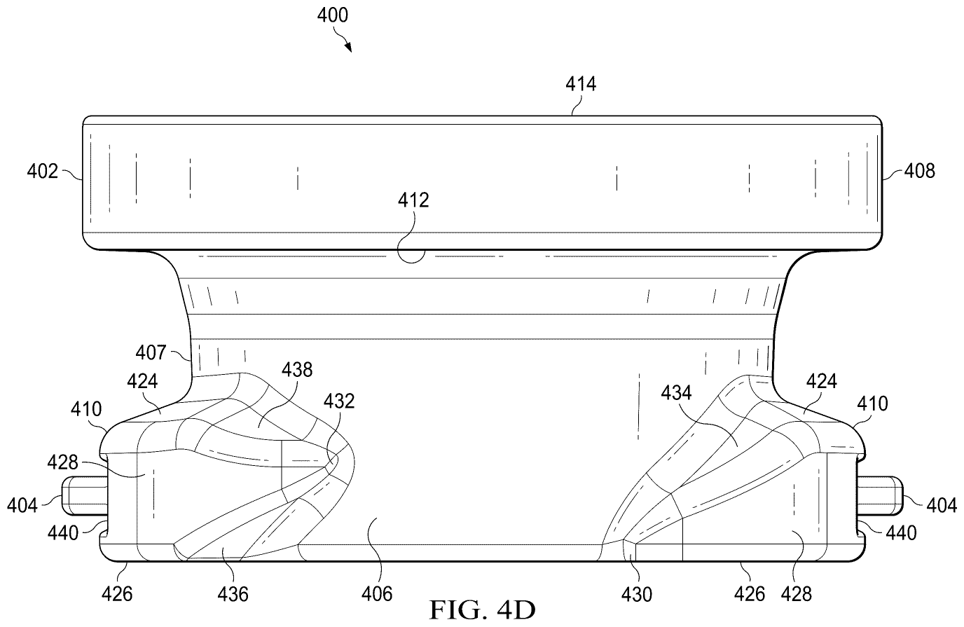

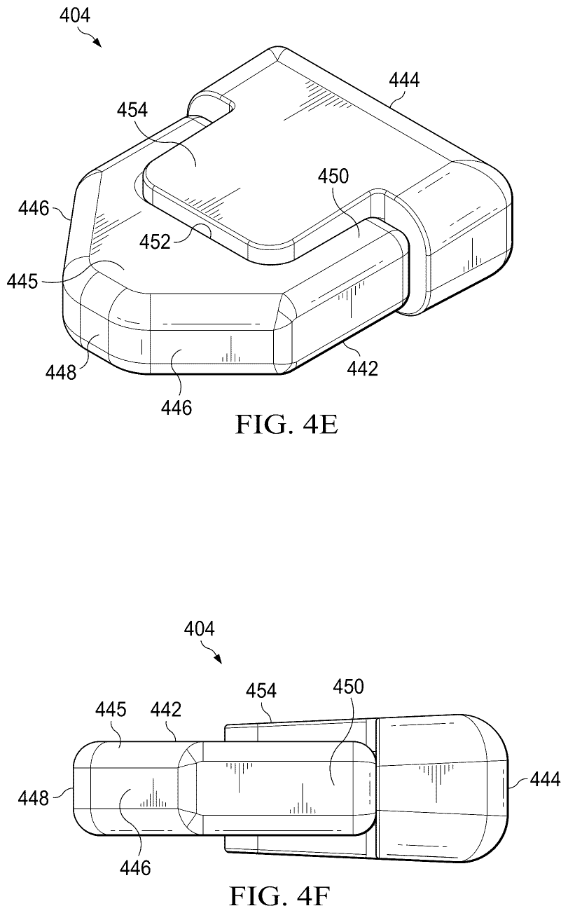

FIGS. 4A-4F illustrate various views of a locking pin assembly 400 for a wear runner assembly 100, according to one or more embodiments of the present disclosure. FIG. 4A is a perspective view, FIG. 4B is a top view, FIG. 4C is a bottom view, and FIG. 4D is a side view of the locking pin assembly 400. FIG. 4E is a top perspective view and 4F is a side view of a lock 404 of the locking pin assembly 400. The locking pin assembly 400 includes a pin 402 and a lock 404.

The pin 402 includes a shaft 406, a head 408, and one or more flanges 410. The head 408 is disposed at the top of the shaft 406. The head 408 may have a larger diameter than the shaft 406 such that the head 408 extends outward relative to the shaft 406. Thus, the head 408 may have a bottom surface 412. The bottom surface 412 may be configured to contact and press or bear against the tabs 332 in the opening 302 of the wear runner 300, as described in more detail below.

The head 408 may also include a top surface 414 opposite the bottom surface 412. The top surface 414 of the head 408 is also the top of the pin 402. The head 408 may include a tool engagement feature 416 that is sunken with respect to the top surface 414. Thus, the top of the tool engagement feature 416 may be below the top surface 414 of the head 408. The tool engagement feature 416 may have a hexagonal outer surface 418 and a hexagonal inner surface 420. The hexagonal inner surface 420 may define a socket 422 and, in some embodiments, the height of the socket 422 may be less than the height of the tool engagement feature 416. There may be a space between the hexagonal outer surface 418 and the rest of the head 408. The hexagonal surfaces 418, 420 allows for insertion and removal of the locking pin assembly 400 in two ways. First, a tool such as a socket wrench may contact or grip the hexagonal outer surface 418 to maneuver the locking pin assembly 400. Second, a tool such as a screw driver or allen wrench may be inserted into the socket 422 and contact the hexagonal inner surface 420 to maneuver the locking pin assembly 400. Thus, if the pin 402 is degraded or worn down during use of the material displacement apparatus, the user has multiple options for removing the locking pin assembly 400 from the wear runner 300 and weld base 200.

The one or more flanges 410 of the pin 402 may extend outward from the bottom of an outer shaft surface 407 of the shaft 406. In the illustrated embodiment, the pin 402 includes two flanges 410 disposed opposite each other around the shaft 406. In other embodiments, the pin 402 may include one flange 410 or more than two flanges 410.

Each flange 410 may include a generally flat top surface 424 and a generally flat bottom surface 426 opposite the flat top surface 424. An outer flange surface 428 may extend between the flat top surface 424 and the flat bottom surface 426. The outer flange surface 428 may be curved from an insertion end 430 to a push-out end 432 of the flange 410.

The insertion end 430 of the flange 410 may comprise a top ramp 434 that is angled downward from the flat top surface 424. The top ramp 434 may be configured to contact and slide against the bottom surface 236 of the tab 234 and into the recess 224 to guide the locking pin assembly 400 into the locked position, as described in more detail below. The top ramp 434 may also contact the sides of the recess 224 to prevent further rotation of the locking pin assembly 400, as described in more detail below.

The push-out end 432 of the flange 410 may include a bottom ramp 436 that is angled upward from the flat bottom surface 426. The bottom ramp 436 may be configured to contact and slide along the ramp 216 in the opening 202 of the weld base 200. During removal, the bottom ramp 436 may provide additional push-out, which may advantageously make it easier for a user to remove the locking pin assembly 400. The bottom ramp 436 may also contact and slide along the ramp 338 of the tab 332 in the opening 302 of the wear runner 300. There may also be an inclined or ramped top surface 438 on the push-out end 432 that extends generally downward from the flat top surface 424 of the flange 410. The inclined surface 438 may be generally planar or may be curved. The inclined surface 438 may provide further assistance in guiding the locking pin assembly 400 during installation and removal.

In some embodiments, the flanges 410 may be arranged so that the insertion end 430 of the first flange 410 is proximate and spaced from the push-out end 432 of the second flange 410. Similarly, the insertion end 430 of the second flange 410 is proximate and spaced from the push-out end 432 of the first flange 410.

Each flange 410 also includes a cavity 440 cut into the outer flange surface 428. The cavity 440 is shaped and configured to fit and hold the lock 404. The lock 404 may include a locking tab 442 and a foot 444. In some embodiments, the foot 444 may be formed of a compressible material such as rubber. In some embodiments, the locking tab 442 may be formed of a non-compressible material or a material that is less compressible than the material of the foot 444, such as a metal material such as steel or an metal or carbide alloy or a hardened polymer or composite, for example only. The foot 444 of the lock 404 may be disposed within the cavity 440 such that the locking tab 442 extends outward from the cavity 440.

Thus, when the locking tab 442 contacts another surface or part, the locking tab 442 may receive a force directed inward towards the shaft 406 of the pin 402. The locking tab 442 may then exert a force on the foot 444 directed inward towards the shaft 406 of the pin 402. The inward force may cause the foot 444 to compress, moving the locking tab 442 further into the cavity 440. In some embodiments, the locking tab 442 may be moved completely into the cavity 440. When the force is removed, the foot 444 may decompress, moving the locking tab 442 outward to its original position (where the locking tab 442 extends outward from the cavity 440).

The locking tab 442 and foot 444 are coupled in any suitable manner. For example, the locking tab 442 and foot 444 may be coupled via an adhesive. The locking tab 442 may have any suitable shape. In the illustrated embodiment, the outer end 445 of the locking tab 442 has two angled surfaces 446 such that the outer end 445 is partially pointed. The angled surfaces 446 are connected by an outer flat surface 448. The outer end 445 may be configured to fit in the pocket 218 in the opening 202 of the weld base 200. The angled surfaces 446 may contact and press against the ridge 228 in the opening 202 of the weld base 200 and the angled surfaces 222 of the pocket 218 in the opening 202 of the weld base 200. Thus, the angled surfaces 446 may allow the lock 404 to be more easily compressed during insertion and/or removal. The inner end 450 of the locking tab 442 may include a slot 452 for receiving an extension 454 on the foot 444. This may provide a better coupling between the locking tab 442 and the foot 444. The foot 444 may be slightly wider than the outer opening of the cavity 440 so that the foot 444 can be compressed into the cavity 440 and remain in the cavity 440 after decompressing.

In some embodiments, the foot 444 comprises a spring. In some embodiments, the foot 444 is non-compressible and the locking tab 442 is compressible. In some embodiments, the foot 444 and the locking tab 442 are both compressible. In some embodiments, the foot 444 and the locking tab 442 are both non-compressible. In some embodiments, the foot 444 and locking tab 442 are a single part. In some embodiments, the cavity 440 is disposed on the shaft 406 of the pin 402 and thus the lock 404 extends from the cavity 440 outward from the shaft 406. In some embodiments, the flanges 410 are not disposed on the bottom of the shaft 406, but are disposed between the bottom of the shaft 406 and the head 408 of the pin 402.

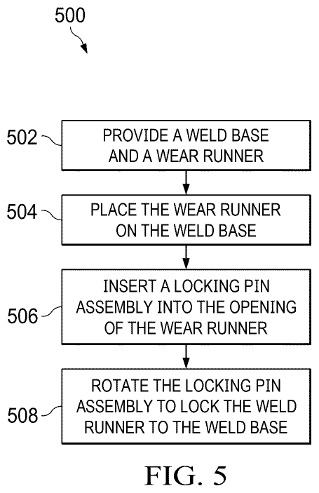

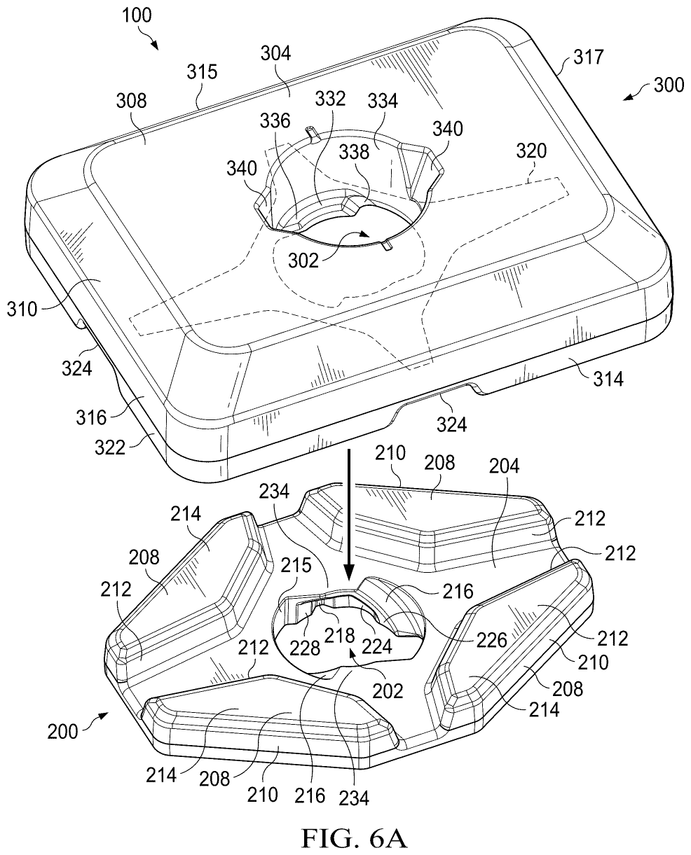

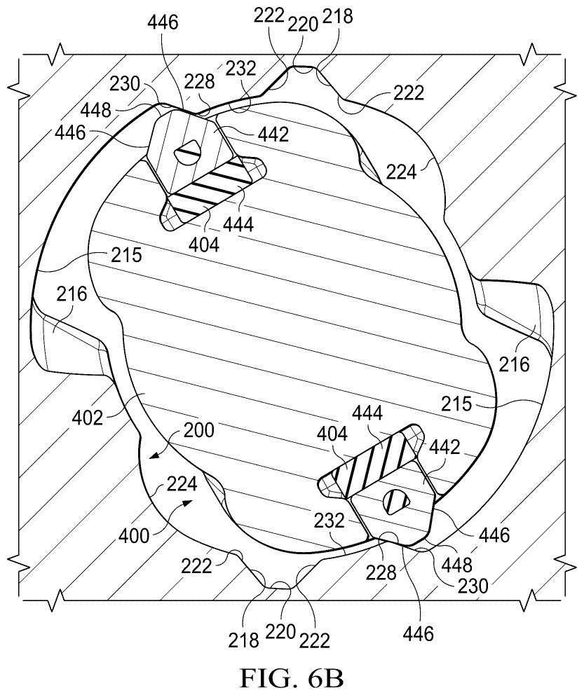

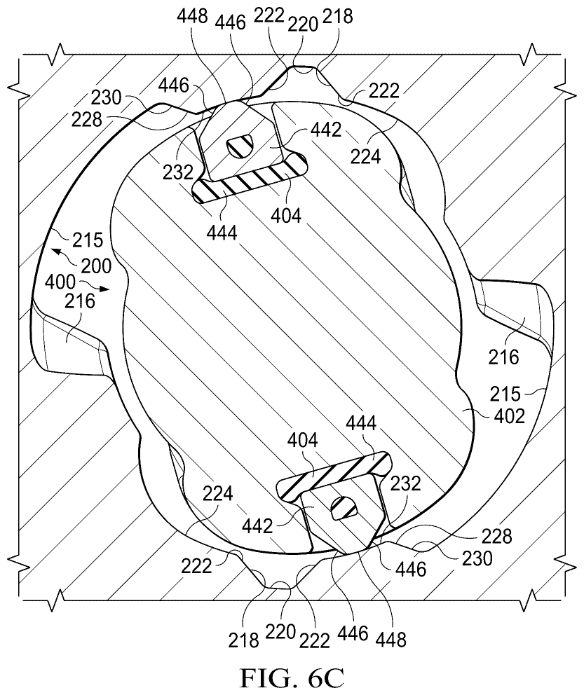

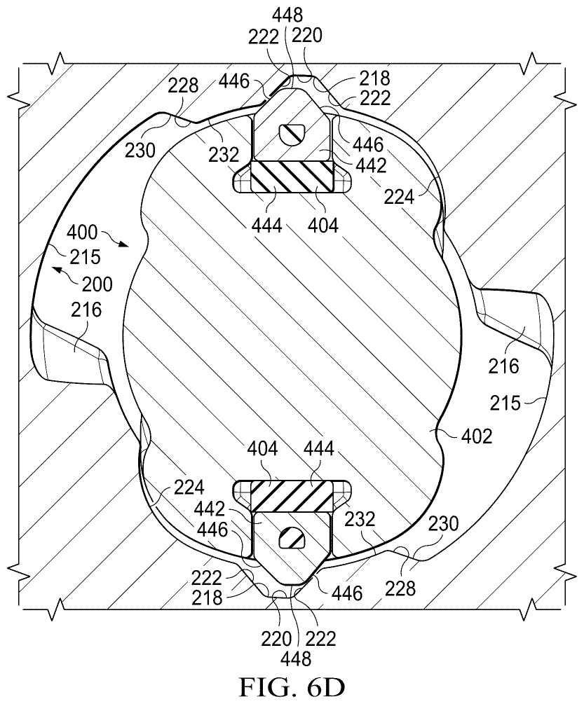

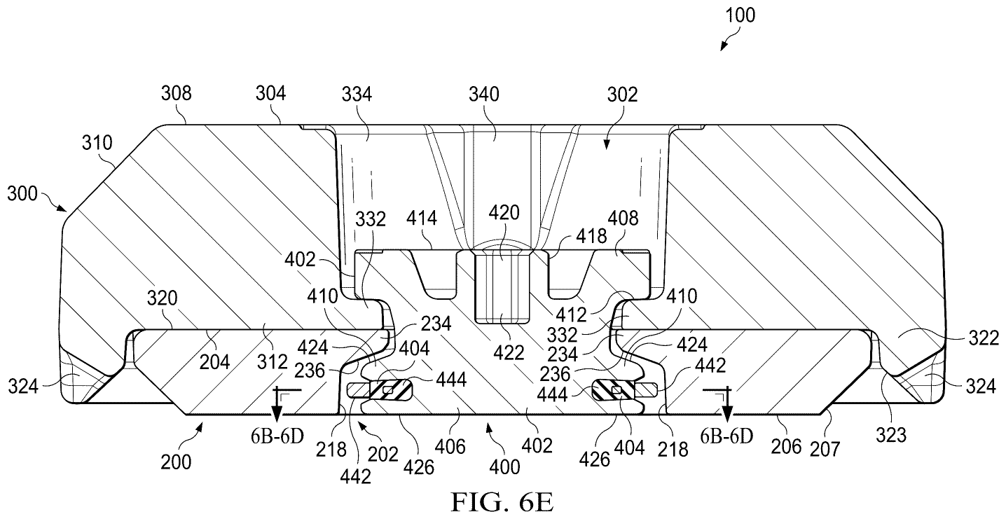

FIG. 5 illustrates a flow chart for a method 500 of assembling a wear runner assembly 100, according to one or more embodiments of the present disclosure. The method 500 will be described in reference to FIGS. 6A-6E.

The method 500 may include the step 502 of providing a weld base 200 and a wear runner 300. The weld base 200 may be any weld base 200 described herein. For example, the weld base 200 may be a weld base 200 illustrated in and/or described in reference to FIGS. 2A-2E. In some embodiments, the weld base 200 may be welded to the surface of a bucket of a material displacement apparatus. The user may weld the weld base 200 along the weld groove 207.

The wear runner 300 may be any wear runner 300 described herein. For example, the wear runner 300 may be a wear runner 300 illustrated in and/or described in reference to FIGS. 3A-3F.

The method 500 may include the step 504 of placing the wear runner 300 on the weld base 200. One or more embodiments of step 504 may be shown in FIG. 6A. The wear runner 300 may be placed on or over the weld base 200 vertical or nearly vertically, as shown by the arrows in FIG. 6A. In other embodiments, the wear runner 300 may be inserted at an angle relative to the vertical. In other embodiments, the wear runner 300 may be rotated as it is placed over the weld base 200.

As described above, the weld base 200 may be symmetrical. For example, in the illustrated embodiment, the weld base 200 is octagonally shaped and symmetrical along a horizontal axis and a vertical axis, when viewed from the top. Similarly, as described above, the wear runner 300 may be symmetrical. For example, in the illustrated embodiment, the wear runner 300 is rectangularly shaped and symmetrical along a horizontal axis and a vertical axis, when viewed from the top. Thus, the wear runner 300 may be placed over the weld base 200 in a first orientation and a second orientation in which the wear runner 300 is rotated 180 degrees from the first orientation. In some embodiments, the weld base 200 and/or wear runner 300 may be shaped as a regular polygon. Thus, in these embodiments, the wear runner 300 may be placed over the weld base 200 in more than two orientations. For example, the wear runner 300 may be a square and the weld base 200 may be a regular octagon and the wear runner 300 may be placed over the weld base 200 in four different orientations. In other embodiments, the wear runner 300 and/or weld base 200 may not be symmetrical or may be symmetrical about only one axis. In these embodiments, the wear runner 300 may only be placed over the weld base 200 in one orientation.

The wear runner 300 is placed over the weld base 200 such that the lower surface 320 of the wear runner 300 contacts the top surface 204 of the weld base 200. Additionally, one or more vertical surfaces 318 of the ribs 312 of the wear runner 300 may contact one or more inner vertical surfaces 212 of the bosses 208 of the weld base 200.

In some embodiments, one or more of the upper surfaces 214 of the bosses 208 of the weld base 200 may be spaced from the bottom surface 306 of the wear runner 300. In some embodiments, the outer vertical surfaces 210 of the bosses 208 of the weld base 200 may be spaced from the wall 322 of the wear runner 300. In some embodiments, the outer vertical surfaces 210 of the bosses 208 of the weld base 200 may also be spaced from the corner shelves 326 of the wear runner 300. These spaced around the exterior of the wear runner 300/weld base 200 assembly may allow a user to observe abrasive wear before the weld base 200 or surface of the bucket are worn down. For example, a hole may form in the wear runner 300 between the top surface 304 and the bottom surface 306. Thus, when the user sees the hole, he or she may determine that the wear runner 300 needs to be replaced.

Therefore, in some embodiments the only contact surfaces between the weld base 200 and the wear runner 300 may be the lower surface 320 of the wear runner 300 contacting the top surface 204 of the weld base 200 and the one or more vertical surfaces 318 of the ribs 312 of the wear runner 300 contacting the one or more inner vertical surfaces 212 of the bosses 208 of the weld base 200. Thus, the inner portions of the wear runner 300 and weld base 200 provide sufficient contact and support to withstand abrasive wearing contact on the wear runner 300 from use of the bucket during use. The contact surfaces between the bosses 208 and the ribs 312 may bear loads in four directions: from side to side and from end to end in both directions. The contact surfaces between the ribs 312 and the top surface 204 of the weld base 200 may bear vertical or top loads.

In some embodiments, the wear runner 300 may be placed on the weld base 200 such that the ramps 338 on the tabs 332 in the opening 302 of the wear runner 300 may align with the ramps 216 in the opening 202 of the weld base 200. In some embodiments, the ramps 338, 216 may form a single ramp.

In some embodiments, the wear runner 300 may fit over the weld base 200 such that the wall 322 extends partially or completely down the height of the weld base 200. Thus, the top surface 304 and outer surface of the wall 322 may mostly cover the weld base 200, preventing material from contacting and wearing the weld base 200 during use of the bucket.

The method 500 may include the step 506 of inserting a locking pin assembly 400 into the opening 302 of the wear runner 300. The locking pin assembly 400 may be any locking pin assembly 400 described herein. For example, the locking pin assembly 400 may be a locking pin assembly 400 illustrated in and/or described in reference to FIGS. 4A-4F.

The locking pin assembly 400 may be inserted such that the head 408 is pointing upwards and in one or more different orientations. In some embodiments, the flat bottom surfaces 426 of the flanges 410 of the locking pin assembly 400 may contact the upper surface 336 of the tab 332 in the opening 302 of the wear runner 300. In some embodiments, the flat bottom surfaces 426 and/or the bottom ramps 436 of the push-out end 432 of the flanges 410 may contact the ramp 338 of the tab 332 in the opening 302 of the wear runner 300.

The method 500 may include the step 508 of rotating the locking pin assembly 400 to lock the wear runner 300 to the weld base 200. One or more embodiments of step 508 may be shown in FIGS. 6B-6D. FIGS. 6B-6D may be cross-sections of the wear runner assembly 100 taken along the 6B-6D-6B-6D line shown in FIG. 1B. The locking pin assembly 400 may be rotate in any suitable manner. In some embodiments, the user may use a tool to rotate the locking pin assembly 400. For example, the user may use a tool such as a socket wrench to contact or grip the hexagonal outer surface 418 of the tool engagement feature 416 on the head 408 of the pin 402 to maneuver the locking pin assembly 400. In another example, the user may insert a tool such as a screw driver or allen wrench into the socket 422 of the tool engagement feature 416 on the head 408 of the pin 402 and contact the hexagonal inner surface 420 to maneuver the locking pin assembly 400.

As the locking pin assembly 400 is rotated in a first direction, the bottom ramp 436 of the push out-end of each flange 410 may contact and slide along the single ramp formed by the ramp 338 of the tab 332 in the opening 302 of the wear runner 300 and the ramp 216 disposed in the opening 202 of the weld base 200. During rotation, the top ramp 434 of the insertion end 430 of the flange 410 may contact the bottom surface 236 of the tab 234 in the opening 202 of the weld base 200. The top ramp 434 may guide the locking pin assembly 400 into the correct position as it approaches the lock position.

When the lock 404 contacts the ridge 228 in the opening 202 of the weld base 200, the locking tab 442 exerts an inward force on the foot 444 of the lock 404. This inward force may compress the foot 444. When the foot 444 compresses, it moves or pulls the locking tab 442 inward such that the locking tab 442 is more disposed more the cavity 440. In some embodiments, the locking tab 442 is completely disposed in the cavity 440 when the foot 444 is compressed and in other embodiments the locking tab 442 is only disposed partially in the cavity 440.

FIG. 6B illustrates the locking tab 442 as it first contacts the ridge 228 of the weld base 200. In some embodiments, an angled surface 446 of the locking tab 442 contacts the ridge 228.

FIG. 6C illustrates the lock 404 after it has been compressed by the ridge 228. At this point, the lock 404 may be at its maximum compression and maximum tension. The locking tab 442 may contact and slide against the compression surface 232 of the ridge 228.

As the locking pin assembly 400 continues to rotate, the locks 404 align with the pockets 218 of the opening 202. When each lock 404 aligns with its respective pocket 218, the foot 444 of the lock 404 decompresses. As the foot 444 decompresses, the locking tab 442 moves or is pushed outward. In some embodiments, the lock 404 may decompress into its original position. The locking tab 442 may extend outward from the cavity 440 and extend into the pocket 218. When the locking tab 442 is disposed in the pocket 218, the locking tab 442 may prevent further movement of the locking pin assembly 400. Thus, this may be considered the lock position of the locking pin assembly 400. In some embodiments, the locking pin assembly 400 may be rotated 90 degrees to move it into the lock position. In the lock position, the locking pin assembly 400 secures the wear runner 300 to the weld base 200. FIGS. 6D-6E illustrate the locking pin assembly 400 in the lock position. FIG. 6E is a cross-section of the assembled wear runner assembly 100 taken along the 6E-6E line in FIG. 1B.

In the lock position, the surfaces 446, 448 of the locking tab 442 may contact one or more surfaces 220, 222 of the pocket 218. The top ramps 434 of the insertion ends 430 of the flanges 410 and/or the outer flange surfaces 428 may contact the surfaces of the recesses 224 in the openings 202 of the weld base 200 to further prevent forward rotation of the locking pin assembly 400. The flat top surfaces 424 of the flanges 410 may contact or be configured to contact the bottom surfaces 236 of the tabs 234 in the opening 202 of the weld base 200. The outer shaft surface 407 of the shaft 406 of the pin 402 may contact and/or bear against the pin shaft contact surface 226 in the opening 202 of the weld base 200. Additionally, the bottom surface 412 of the head 408 may contact, press, and/or bear against the upper surfaces 336 of the tabs 332 in the opening 302 of the wear runner 300. In some embodiments, the flat bottom surfaces 426 of the flanges 410 may contact or be configured to contact the top surface 204 of the weld base. One or more of these contact surfaces between the locking pin assembly 400 and the opening 202 of the weld base 200 and the opening 302 of the wear runner 300 may prevent movement of the wear runner 300 and locking pin assembly 400 relative to the weld base 200. The contact surfaces may secure the wear runner 300 and locking pin assembly 400 to the weld base 200 during use of the bucket. In particular, the flat top surfaces 424 of the flanges 410 may contact or be configured to contact the bottom surfaces 236 of the tabs 234 in the opening 202 of the weld base 200 to prevent lifting off of the locking pin assembly 400. In some embodiments, the flanges 410 do not carry load, but serve to maintain the coupling between the wear runner 300 and weld base.

The locking pin assembly 400 may be removed by rotating the locking pin assembly 400 in the opposite direction that it was rotated in for installation. Thus, steps 508 and 506 may be performed in reverse to rotate the locking pin assembly 400 such that it moves upward and out of the opening 202 of the weld base 200 and the opening 302 of the wear runner 300. The bottom ramps 436 of the push-out ends 432 of the flanges 410 may slide along and push against the single ramps formed by the ramps 338 of the tab 332 in the opening 302 of the wear runner 300 and the ramps 216 disposed in the opening 202 of the weld base 200. This may make it easier for the user to rotate the locking pin assembly 400 out. The inclined top surface 438 of the push-out end 432 may help to guide the locking pin assembly 400 as it is rotated out. The user may insert a tool into the pin pry features 340 in the opening 302 of the wear runner 300 to pry the locking pin assembly 400 out of the openings 302, 202. The tool may be inserted into the pin pry feature 340 and under the head 408 of the pin 402 such that the tool contacts the bottom surface 412 of the head 408 to pry it out of the opening 302.

Similarly, to remove the wear runner 300 from the weld base 200, step 504 may be performed in reverse. The user may insert a tool into the pry features 324 on the wall 322 of the wear runner 300 to pry the wear runner 300 off of the weld base 200.

Once removed, the wear runner 300 and locking pin assembly 400 may be discarded. In some embodiments, the wear runner 300 and/or locking pin assembly 400 may be reused on a different weld base 200. The locking pin assembly 400 may be used in a different type of wear assembly such as a tooth and/or an adapter for a nose of the lip or a shroud for a lip of the bucket. In some embodiments, a new wear runner 300 and/or locking pin assembly 400 may be secured to the same weld base 200. In some embodiments, the weld base 200 may also be replaced.

The wear runner 300, weld base 200, and pin 402 may be formed of any suitable material, including a cast iron, steel, or other material.

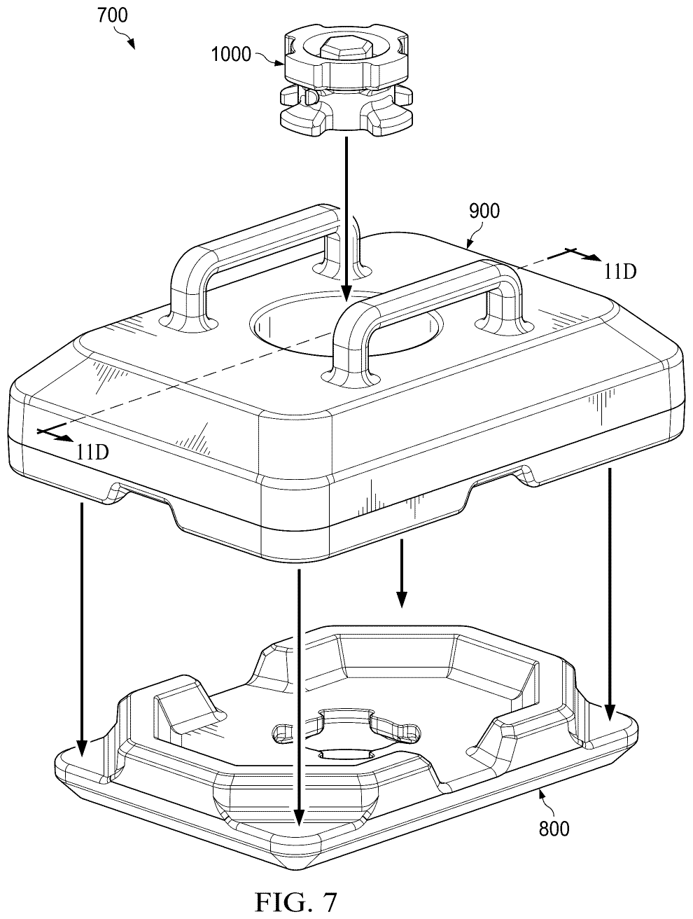

FIGS. 7-11E illustrate another embodiment of a wear runner assembly 700, according to one or more embodiments of the present disclosure. FIG. 7 illustrates an exploded view of the wear runner assembly 700.

The wear runner assembly includes a weld base 800, a wear runner 900, and a locking pin assembly 1000. The weld base 800 is affixed to the surface of the bucket by any suitable means. For example, the weld base 800 may be welded to the surface of the bucket. The wear runner 900 may be disposed over part or all of the weld base 800. The locking pin assembly 1000 may be disposed through aligned openings in the wear runner 900 and weld base 800 thereby coupling the wear runner 900 to the weld base 800.

In some embodiments, the weld base 800, also referred to herein as a base 800, may be non-removably or permanently affixed to the surface of the bucket, such as through integral formation or welding. The wear runner 900 may be removably coupled to the weld base 800 via the locking pin assembly 1000. The locking pin assembly 1000 may be removed from the aligned openings, thus allowing the wear runner 900 to be removed from the weld base 800. Thus, the wear runner assembly 700 may be designed so that the wear runner 900 and/or locking pin assembly 1000 are more exposed, with the wear runner bearing the brunt of the abrasive, wearing contact from the material displaced during use of the material displacement equipment. The wear runner 900 and locking pin assembly 1000 may be removed and replaced when the wear runner 900 and/or locking pin assembly 1000 experience sufficient wear. In this way, the wear runner assembly 700 may prevent wear of the underlying surface of the bucket.

In other embodiments, the weld base 800 may be removably affixed to the bucket. In yet other embodiments, the wear runner 900 and/or locking pin assembly 1000 may be non-removably coupled to the weld base 800.

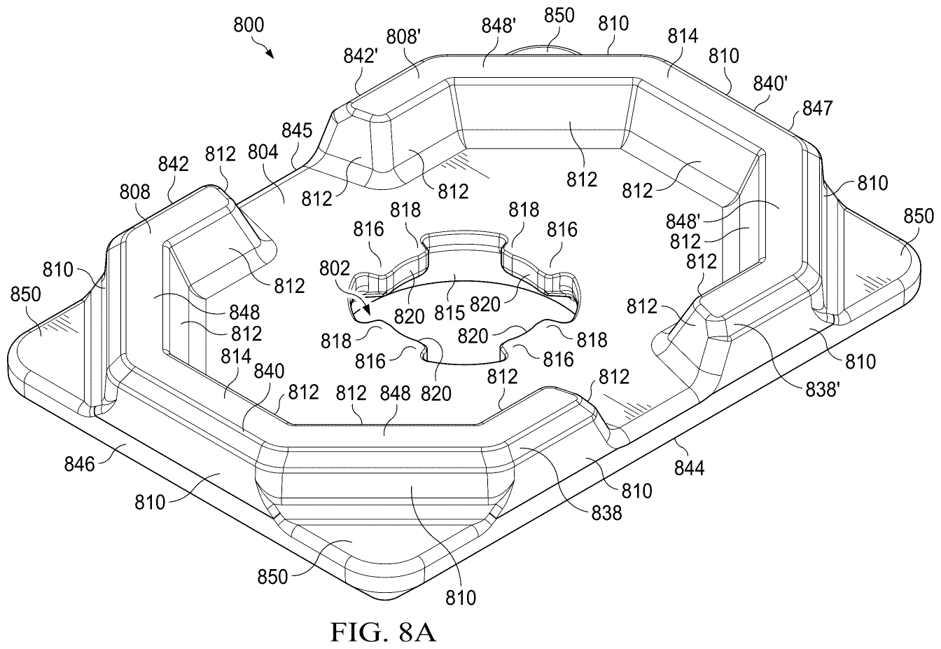

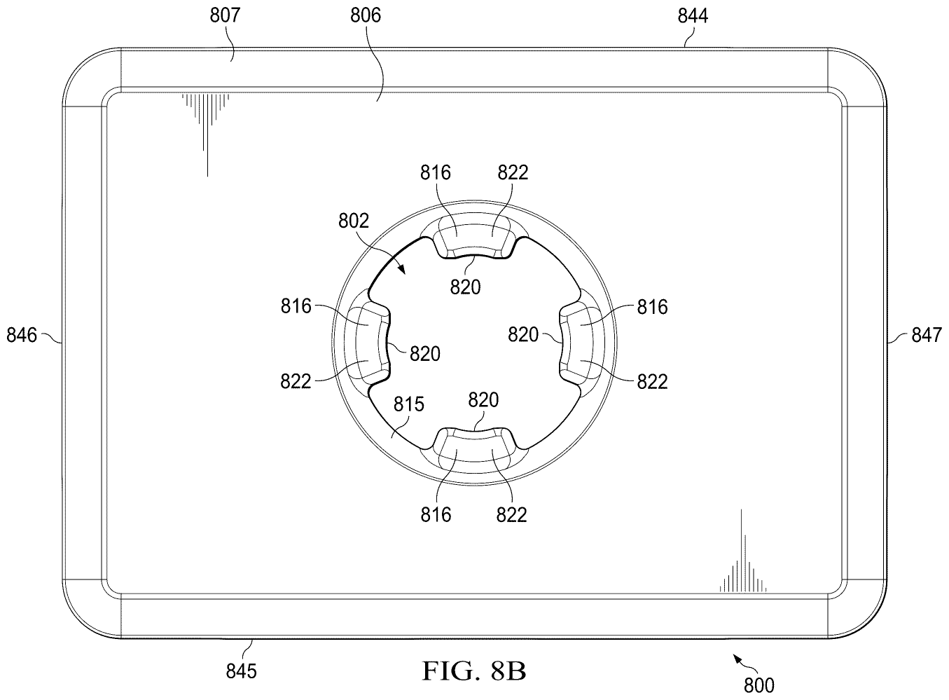

FIGS. 8A-8B illustrate various views of a weld base 800 for a wear runner assembly 700, according to one or more embodiments of the present disclosure. FIG. 8A illustrates a perspective top view of the weld base 800 and FIG. 8B illustrates a bottom view of the weld base 800. The weld base 800 includes a top surface 804 and a bottom surface 806. The opening 802 extends from the top surface 804 to the bottom surface 806. The opening 802 may be disposed at a center of the weld base 800. However, in other embodiments, the opening 802 may be off-center.

The bottom of the weld base 800 may include one or more weld grooves 807 disposed around part or all of the perimeter of the weld base 800. The weld grooves 807 may be angled upward from the bottom surface 806. The weld grooves 807 may allow the weld base 800 to be welded to the surface of a bucket. The weld grooves 807 may also advantageously reduce the amount of material needed to form the weld base 800 decreasing the weight and lowering the cost.

In some embodiments, the perimeter of the weld base 800 may be rectangularly shaped as shown in the illustrated embodiment. However, the weld base 800 may be any suitable shape. For example, the weld base 800 may be an octagon, square, hexagon, circle, oval, or any other suitable shape. The weld base 800 may also be symmetrical. For example, when viewed from the top, the weld base 800 may be symmetrical along a horizontal axis and a vertical axis.

The weld base 800 includes one or more bosses 808 that project upwards from the top surface 804. The bosses 808 may extend along the sides and/or corners of the weld base 800. For example, as shown in the illustrated embodiment, a boss 808 may be generally C-shaped, having a first portion 838 extending along a first lateral side 844, a second portion 840 extending along a first end 846, and a third portion 842 extending along a second lateral side 845 opposite the first lateral side 844. Connecting portions 848 may connect the first portion 838 to the second portion 840 and the second portion 840 to the third portion 842. A second boss 808′ may be generally C-shaped, having a first portion 838′ extending along the first lateral side 844, a second portion 840′ extending along a second end 847 opposite the first end 846, and a third portion 842′ extending along the second lateral side 845. Connecting portions 848′ may connect the first portion 838′ to the second portion 840′ and the second portion 840′ to the third portion 842′. In some embodiments, the bosses 808, 808′ may be arranged around the outer portion of the top surface 804 such that the bosses 808, 808′ form an inner space in the weld base 800.

The connecting portions 848 may extend diagonally between the first side 844 and the first end 846 and the second side 845 and the first end 846. The connecting portions 848′ may extend diagonally between the first side 844 and the second end 847 and the second side 845 and the second end 847. Thus, a corner portion 850 of the top surface 804 is formed between the connecting portions 848, 848′ and the perimeter of the weld base 800.

There may be any suitable number of bosses 808 on the weld base 800. For example, in the illustrated embodiment, the weld base 800 may include two bosses 808, 808′ that are disposed on different ends 846, 847. However, the weld base 800 may include 1, 2, 3, 5, 6, 7, 8, 9, or 10 bosses 808.

The bosses 808, 808′ include one or more outer vertical surfaces 810 oriented outward from the centerline of the weld base 800. These outer vertical surfaces 810 may be disposed along part or all of the perimeter of the weld base 800. The bosses 808 also include one or more inner vertical surfaces 812 oriented generally inward towards a centerline of the weld base 800. Unlike the weld base 200 illustrated in FIGS. 1A-6E, in the weld base 800 illustrated in FIGS. 7-11E, the outer vertical surfaces 810 may be bearing surfaces configured to contact and bear or press against corresponding vertical surfaces on the wear runner 900, as described in more detail below. The bosses 808, 808′ also include an upper surface 214, 214′. The upper surfaces 214, 214′ of the bosses 808, 808′ are raised with respect to the top surface 804 of the weld base 800. The intersection between the outer vertical surfaces 810 and the upper surface 814 and the inner vertical surfaces 812 and the upper surface 814 may be curved such that the intersection is generally smooth.

The top surface 804 of the weld base 800 may be generally octagonal, as shown in the illustrated embodiment. The top surface 804 may be configured to contact a corresponding horizontal surface on the wear runner 900, as described in more detail below. In some embodiments, the corner portions 850 of the top surface 804 may be configured to contact the corresponding horizontal lower surfaces of the corner shelves of the wear runner 900, as described in more detail below. In other embodiments, the top surface 804 may be any suitable shape. For example, the top surface 804 may be rectangular, circular, ovular, T-shaped, L-shaped, V-shaped, or any other suitable shape.

The opening 802 of the weld base 800 is shaped to fit and secure a locking pin assembly 1000. The opening 802 may be defined by a wall 815 surrounding the opening 802. The opening 802 includes one or more tabs 816. For example, in the illustrated embodiment, the opening 802 includes four tabs 816. The tabs 816 extend from the wall 815 towards the center of the opening 802. The tabs 816 may be aligned with the top surface 804 of the weld base 800 such that the top surface 818 of the tabs 816 is aligned with the top surface 804. The tabs 816 have an outer surface 820 on the end of the tabs 816. The outer surface 820 is curved for contacting a lock of the locking pin assembly 1000, as described in more detail below. The bottom surface 822 of the tabs 816 may be angled downward from the outer surface 820 to the wall 815. The bottom surface 822 of the tab 816 may be configured to contact a top surface of a lower flange of the locking pin assembly 1000, as described in more detail below.

In some embodiments, the opening 802 may include any suitable number of tabs 816. For example, the opening 802 may include 1, 2, 3, 5, 6, 7, 8, 9, or 10 tabs 816. In some embodiments, the bottom surface 822 of the tabs 816 is not angled. In some embodiments, the outer surface 820 is not curved. In some embodiments, the outer surface 820 includes a pocket or cavity for fitting a lock of the locking pin assembly 1000. In some embodiments, the tabs 816 are not aligned with the top surface 804 and instead are spaced downward from the top surface 804 within the opening 802. In some embodiments, the tabs 816 are not all aligned and may be spaced along the length of the wall 815.

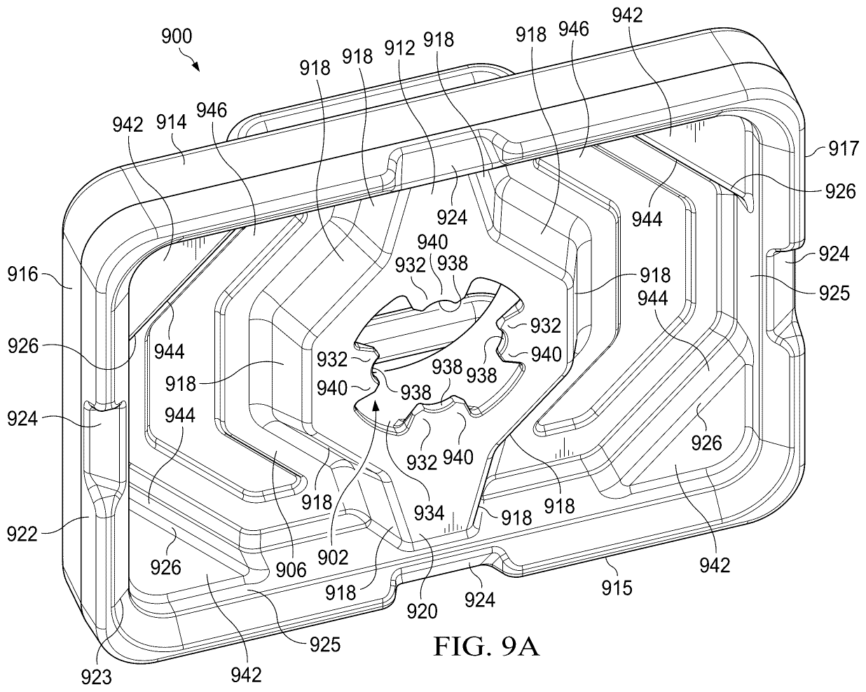

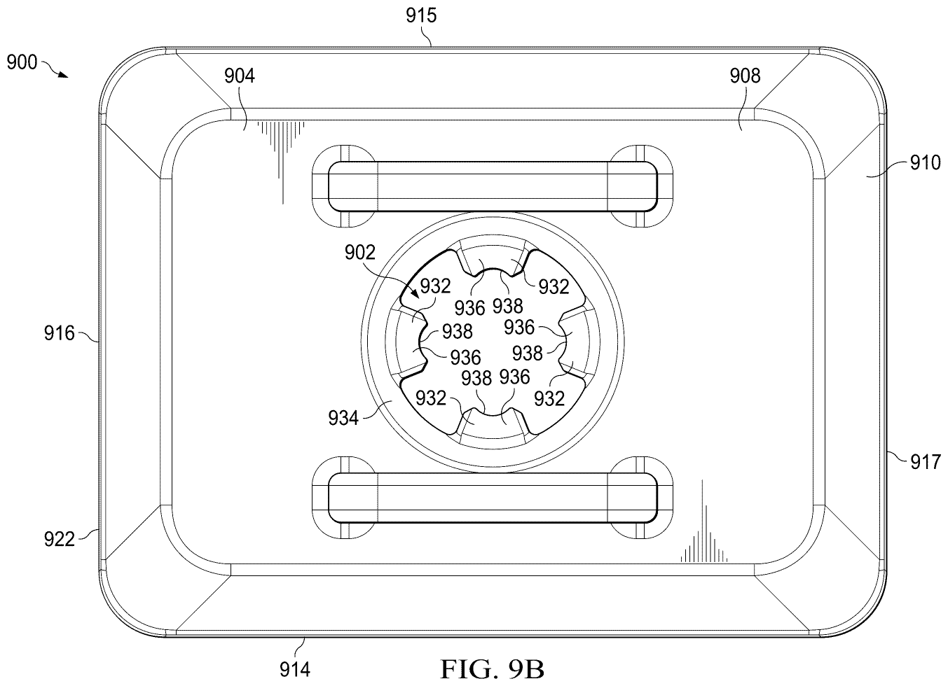

FIGS. 9A-9B illustrate various views of a wear runner 900 for use in a wear runner assembly 700, according to one or more embodiments of the present disclosure. FIG. 9A is a perspective bottom view of the wear runner 900 and FIG. 9B is a top view of the wear runner 900. The wear runner 900 includes a top surface 904, a bottom surface 906, and an opening 902 extending from the top surface 904 to the bottom surface 906. In some embodiments, the bottom surface 806 may include one or more depressions 946 sunken with respect to the bottom surface 806. These depressions 946 may reduce the amount of material needed to form the wear runner 900 decreasing the weight and lowering the cost.

The top surface 904 may include a central flat portion 908 and an inclined outer portion 910. The inclined outer portion 910 may be inclined downward from the central flat portion 908 around the edges of the top surface 904. In some embodiments, the top surface 904 may only have a flat portion 908. In other embodiments, the top surface 904 may be partially or completely curved or may be pyramid-shaped.

In some embodiments, the perimeter of the wear runner 900 may be rectangularly shaped as shown in the illustrated embodiment. However, the wear runner 900 may be any suitable shape. For example, the wear runner 900 may be a square, hexagon, octagon, circle, oval, or any other suitable shape. The wear runner 900 may also be symmetrical. For example, when viewed from the top, the wear runner 900 may be symmetrical along a horizontal axis and a vertical axis.

The wear runner 900 may include one or more ribs 912 projecting downward from the bottom surface 906. The ribs 912 may extend along any suitable portion of the wear runner 900. In the illustrated embodiment, a rib 912 extends from a first lateral side 914 to an opposite, second lateral side 915.

The rib 912 may include one or more vertical surfaces 918 and a generally flat or horizontal lower surface 820. The intersection between the vertical surfaces 918 and the lower surface 920 and the vertical surfaces 918 and the bottom surface 906 may be curved such that the intersection is generally smooth. The lower surface 920 may be configured to contact and press or bear against the top surface 804 of the weld base 800.

The vertical surfaces 918 may extend from the bottom surface 906 of the wear runner 900 to the lower surface 920. The vertical surfaces 918 may be disposed around the rib 918 such that the face outward from the centerline of the wear runner 900.

In some embodiments, the rib 812 does not extend from side 914 to side 915, or end 916 to end 917. Instead, the rib 912 may project from a center of the bottom surface 806 or at a location off-center but spaced from the sides 914, 915 and ends 916, 917. In some embodiments, there may be more than one ribs 912.

In some embodiments, the first end 916 may be considered a front end and the second end 917 may be considered a back end. However, in some embodiments, as in the illustrated embodiment, the wear runner 900 does not have a front or back end.

The wear runner 900 may also include a wall 922 that projects downward from the bottom surface 306 along the perimeter of the wear runner 900. The wall 922 may extend partially or completely along the wear runner 900. In the illustrated embodiment, the wall 922 extends completely around the perimeter such that it extends along the first side 914, the first end 916, the second side 915, and the second end 917. There may be an inner surface 925 on the wall 922 that faces an interior of the wear runner 900. The wall 922 may include an inclined surface 923 that angles upward from the bottom of the wall 922 to the inner surface 925 of the wall 922. In some embodiments, the wall 922 may also include an inclined surface facing outward away from the centerline of the wear runner 900 along an outer surface of the wall 922. In some embodiments, there may be more than one wall 922. In other embodiments, there may be no wall 922.

The wall 922 may comprise one or more pry features 924. For example, the pry features 924 may be cut into the wall 922 from the bottom. In other embodiments, the pry features 924 are formed as openings, cavities or recesses in other parts of the wall 922. The pry features 924 may be disposed on at least one of the first side 914, the first end 916, the second side 915, and/or the second end 917. The pry features 924 may be shaped and configured for a tool (e.g. pry bar) to be inserted therein. After the wear runner 900 is placed over the weld base 800, a user may insert the tool into the pry feature 924 to pry the wear runner 900 off of the weld base 800. Thus, the pry feature 824 may include a ramp or inclined surface to provide additional leverage for prying the wear runner 900. In some cases, a hammer may not be needed to pry the wear runner 900 off of the weld base 800. The pry features 924 may also advantageously reduce the amount of material needed to form the wear runner 900 decreasing the weight and lowering the cost.

The wear runner 900 may also include one or more corner shelves 926. A corner shelf 926 may extend downward from the corner of the bottom surface 906 and may contact the wall 922. The corner shelf 926 may have a height shorter than that of the neighboring wall 922. In some cases, the horizontal lower surface 942 of the corner shelf 926 may be spaced from the inclined surface 923 of the wall 322. A vertical surface 944 extends from the horizontal lower surface 942 to the bottom surface 906 of the wear runner 900. Unlike the wear runner 300 illustrated in FIGS. 1A-6E, the vertical surfaces 944 of the corner shelves 926 of the wear runner 900 illustrated in FIGS. 7-11E are configured to contact the outer vertical surfaces 810 of the bosses 808 of the weld base 800. In some embodiments, the horizontal lower surfaces 942 of the corner shelves 926 may be configured to contact the corner portions 850 of the top surface 804 of the weld base 800.

The opening 902 of the wear runner 900 may be disposed through the rib 912 such that the opening 902 extends from the top surface 904 of the wear runner 900 to the lower surface 920 of the rib 912. In some embodiments, as in the illustrated embodiment, the opening 902 may be disposed at a center of the wear runner 900. However, the opening 902 may also be disposed off-center. In some embodiments, the opening 902 may not extend through the rib 912 and may instead extend from the top surface 904 to the bottom surface 906.

The opening 902 of the wear runner 900 is shaped to fit and secure a locking pin assembly 1000. The opening 902 may be defined by a wall 934 surrounding the opening 902. The opening 902 includes one or more tabs 932. For example, in the illustrated embodiment, the opening 902 includes four tabs 932. The tabs 932 extend from the wall 934 towards the center of the opening 902. The tabs 932 may be aligned with the bottom surface 906 of the wear runner 900 such that the bottom surface 940 of the tabs 932 is aligned with the bottom surface 906. The tabs 932 have an outer surface 938 on the end of the tabs 932. The outer surface 938 is curved for contacting a lock of the locking pin assembly 1000, as described in more detail below. The top surface 936 of the tabs 816 may be angled downward from the outer surface 938 to the wall 934. The top surface 936 of the tab 932 may be configured to contact a bottom surface of an upper flange of the locking pin assembly 1000, as described in more detail below.

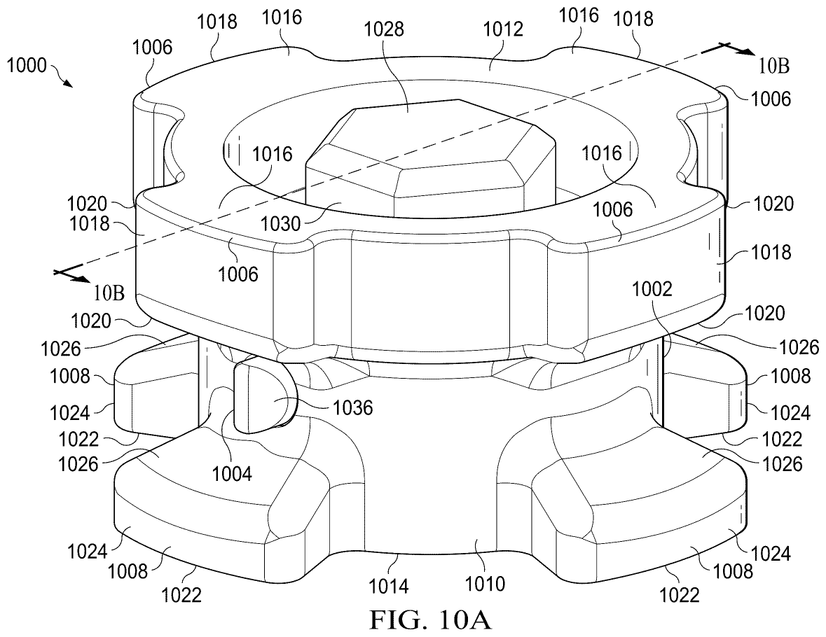

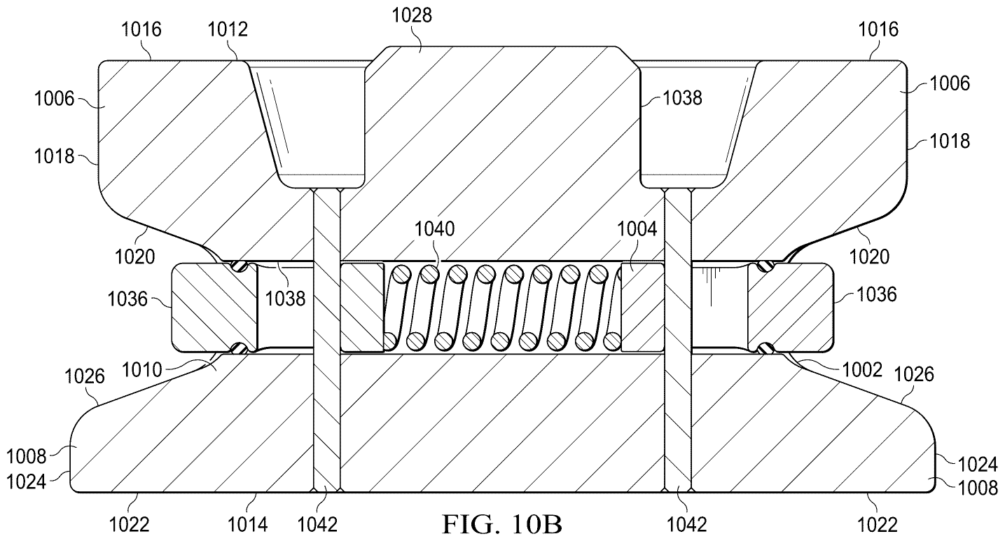

In some embodiments, the opening 902 may include any suitable number of tabs 932. For example, the opening 902 may include 1, 2, 3, 5, 6, 7, 8, 9, or 10 tabs 916. In some embodiments, the top surface 936 of the tabs 932 is not angled. In some embodiments, the outer surface 938 is not curved. In some embodiments, the outer surface 938 includes a pocket or cavity for fitting a lock of the locking pin assembly 1000. In some embodiments, the tabs 932 are not aligned with the bottom surface 906 and instead are spaced upward from the bottom surface 906 within the opening 902. In some embodiments, the tabs 932 are not all aligned and may be spaced along the length of the wall 934. FIGS. 10A-10B illustrate various views of a locking pin assembly 1000 for a wear runner assembly 700, according to one or more embodiments of the present disclosure. FIG. 10A illustrates a perspective view of the locking pin assembly 1000 and FIG. 10B illustrates a cross-sectional view of the locking pin assembly 1000 through the 10B-10B line in FIG. 10A.

The locking pin assembly 1000 includes a pin 1002 and a lock 1004. The pin 1002 includes a set of upper flanges 1006 and a set of lower flanges 1008. The upper flanges 1006 extend outward from the shaft 1010 of the pin 1002 along the top 1012 of the shaft 1010. Thus, the top surfaces 1016 of the upper flanges 1006 may be aligned with the top surface 1012 of the pin 1002. The upper flanges 1006 also have outer surfaces 1018 that may be curved. In some embodiments, the outer surfaces 1018 may be configured to contact the wall 934 of the opening 902 of the wear runner 900. In other embodiments, the outer surfaces 1018 may be spaced from the wall 934 of the opening 902. The bottom surfaces 1020 of the upper flanges 1006 are angled downward from the outer surface 1018 towards the shaft 1010. The bottom surfaces 1020 of the upper flanges 1006 are configured to contact the top surfaces 936 of the tabs 932 in the opening 902 of the wear runner 900 in the locked position, as described in more detail below.

In some embodiments, the pin 1002 may include any suitable number of upper flanges 1006. For example, the pin 1002 may include 1, 2, 3, 5, 6, 7, 8, 9, or 10 upper flanges 1006. In some embodiments, the bottom surfaces 1020 of the upper flanges 1006 are not angled. In some embodiments, the outer surfaces 1018 are not curved. In some embodiments, the upper flanges 1006 are not aligned with the top surface 1012 of the shaft 1010 and instead are spaced downward from the top surface 1012 along the shaft 1010. In some embodiments, the upper flanges 1006 are not all aligned and may be spaced along the length of the shaft 1010.

The lower flanges 1008 extend outward from the shaft 1010 of the pin 1002 along the bottom 1014 of the shaft 1010. Thus, the bottom surfaces 1022 of the lower flanges 1008 may be aligned with the bottom surface 1014 of the pin 1002. The lower flanges 1008 also have outer surfaces 1024 that may be curved. In some embodiments, the outer surfaces 1024 may be configured to contact the wall 815 of the opening 802 of the weld base 800. In other embodiments, the outer surfaces 1024 may be spaced from the wall 815 of the opening 802. The top surfaces 1026 of the lower flanges 1008 are angled upward from the outer surface 1024 towards the shaft 1010. The top surfaces 1026 of the lower flanges 1008 are configured to contact the bottom surfaces 822 of the tabs 816 in the opening 802 of the weld base 800 in the locked position, as described in more detail below.

In some embodiments, the pin 1002 may include any suitable number of upper flanges 1006. For example, the pin 1002 may include 1, 2, 3, 5, 6, 7, 8, 9, or 10 upper flanges 1006. In some embodiments, the bottom surfaces 1020 of the upper flanges 1006 are not angled. In some embodiments, the outer surfaces 1018 are not curved. In some embodiments, the upper flanges 1006 are not aligned with the top surface 1012 of the shaft 1010 and instead are spaced downward from the top surface 1012 along the shaft 1010. In some embodiments, the upper flanges 1006 are not all aligned and may be spaced along the length of the shaft 1010.

The upper flanges 1006 are generally aligned with the lower flanges 1008 such that each upper flange 1006 is radially paired with a lower flange 1008. However, in other embodiments, the upper flanges 1006 may be radially offset from the lower flanges 1008.

Top surface 1012 of the pin 1002 may include a tool engagement feature 1028 that is sunken with respect to the top surface 1012. Thus, the top of the tool engagement feature 1028 may be below the top surface 1012. The tool engagement feature 1028 may have a hexagonal outer surface 1030. There may be a space between the hexagonal outer surface 1030 and the rest of the pin 1002. A tool such as a socket wrench may contact or grip the hexagonal outer surface 1030 to maneuver the locking pin assembly 1000.

The lock 1004 extends through a cavity 1038 in the shaft 1010 of the pin 1002. The lock 1004 includes include two locks 1036 that extend outward from the shaft 1010. The lock 1004 includes a biasing mechanism that biases the locks 1036 outward from the cavity 1038. The biasing mechanism may include a spring 1040 such as a compression spring. Each end of the spring 1040 may contact a locking tab 1036 and bias the locks 1036 outward. One or more rods 1042 may extend from the top 1012 of the pin 1002 to the bottom 1014, through the cavity 1038. The spring 1040 may be disposed between the rods 1042. Each locking tab 1036 may hook around one of the rods 1042 such that the locking tab 1036 can move inward and outward in the cavity 1038 without extending too far out of the cavity 1038 or without falling out of the cavity 1038. Thus, the rods 1042 may prevent the locks 1036 from disengaging from the lock 1004.

Each locking tab 1036 of the lock 1004 may be aligned with a pair of an upper flange 1006 and lower flange 1008. In other embodiments, each locking tab 1036 may be offset from the pairs of an upper flange 1006 and lower flange 1008 such that the lock is radially spaced between neighboring pairs. In other embodiments, the lock 1004 extends through opposing upper flanges 1006 or opposing lower flanges 1008. The locks 1036 may be configured to contact the outer surfaces 820 of opposing tabs 816 in the opening 802 of the weld base 800 and the outer surfaces 938 of opposing tabs 932 in the opening 902 of the wear runner 900, as described in more detail below.

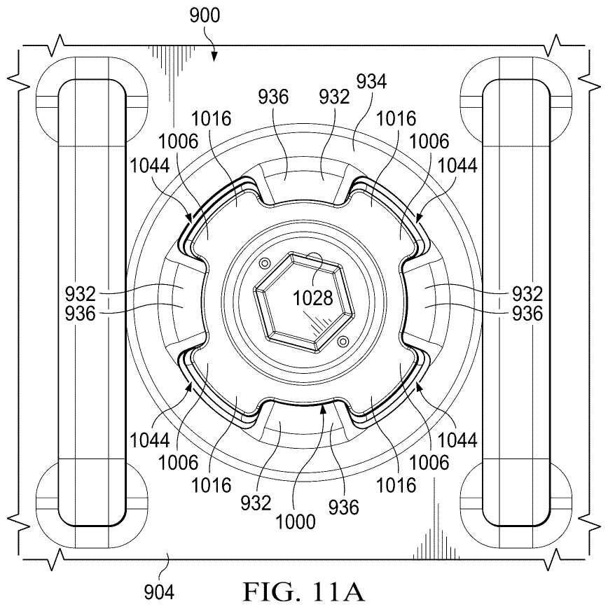

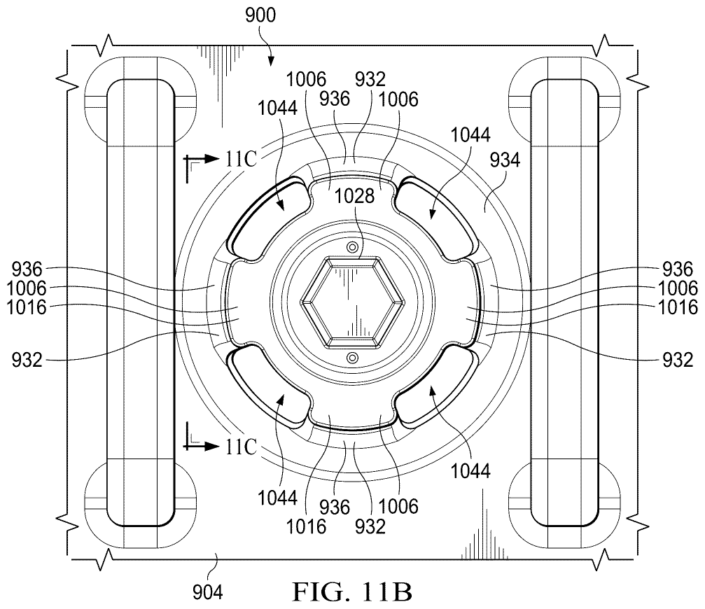

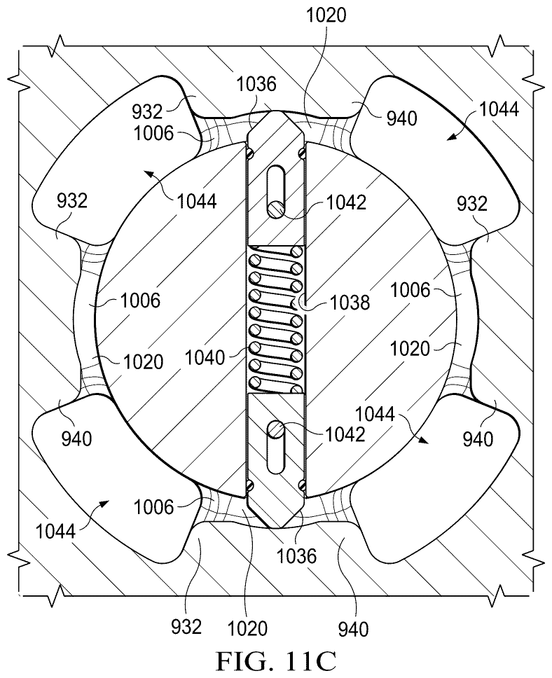

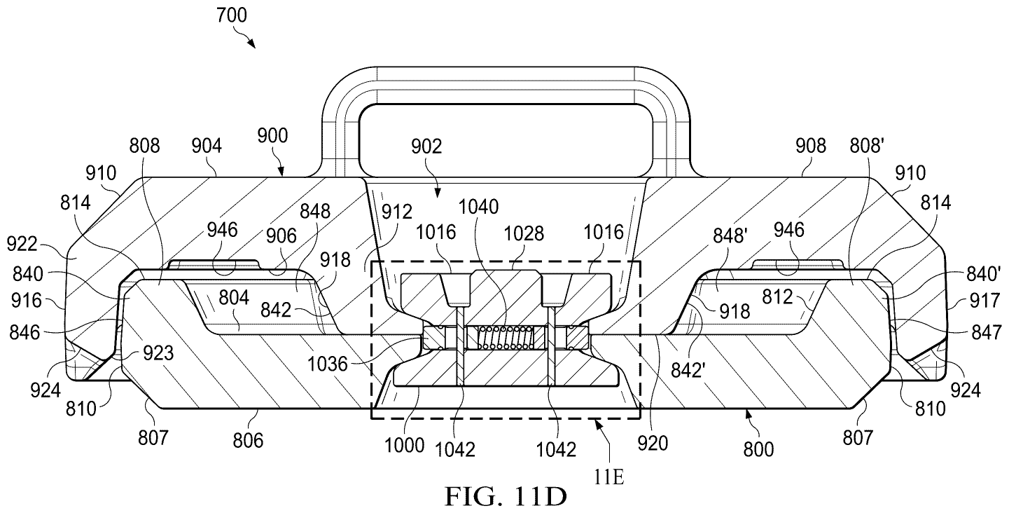

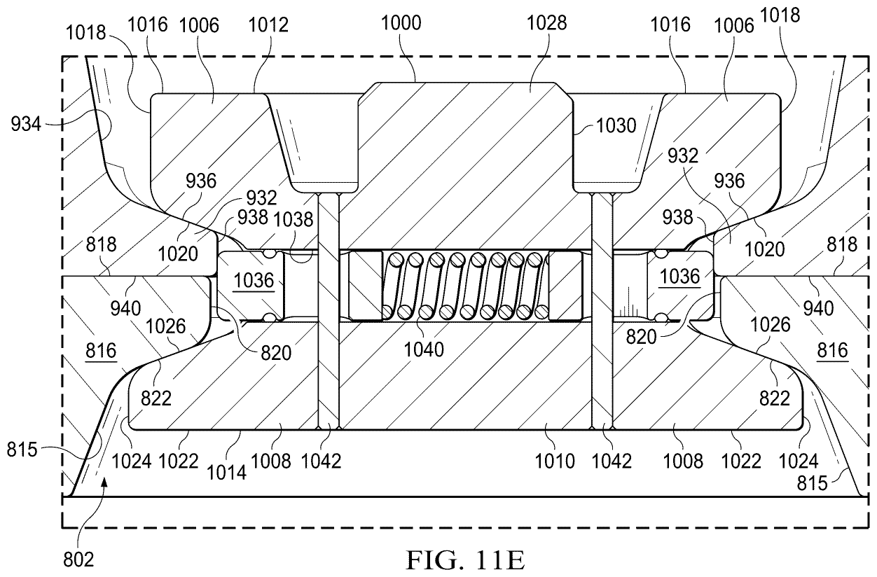

The wear runner assembly 700 shown in FIGS. 7-10B may be assembled according to the same basic steps 502-508 of method 500 illustrated in FIG. 5. FIGS. 11A-11E illustrate how these steps 502-508 apply to assembling the wear runner assembly 700.

Step 502 includes providing a weld base 800 and a wear runner 900. The weld base 800 may be the weld base 800 described in reference to FIGS. 8A-8B. In some embodiments, the weld base 800 may be welded to the surface of a bucket of a material displacement apparatus. The user may weld the weld base 800 along the weld groove 807. The wear runner 900 may be the wear runner 900 described in reference to FIGS. 9A-9B.

Step 504 includes placing the wear runner 900 on the weld base 800. The wear runner 900 may be placed on or over the weld base 800 vertical or nearly vertically, similar to how the wear runner 300 is placed over the weld base 200 in FIG. 6A. In other embodiments, the wear runner 900 may be inserted at an angle relative to the vertical. In other embodiments, the wear runner 900 may be rotated as it is placed over the weld base 800.

As described above, the weld base 800 may be symmetrical. For example, in the illustrated embodiment, the weld base 800 is rectangularly shaped and symmetrical along a horizontal axis and a vertical axis, when viewed from the top. Similarly, as described above, the wear runner 900 may be symmetrical. For example, in the illustrated embodiment, the wear runner 900 is rectangularly shaped and symmetrical along a horizontal axis and a vertical axis, when viewed from the top. Thus, the wear runner 900 may be placed over the weld base 200 in a first orientation and a second orientation in which the wear runner 900 is rotated 180 degrees from the first orientation.

The wear runner 900 is placed over the weld base 800 such that the lower surface 920 of the rib 912 of the wear runner 900 contacts the top surface 804 of the weld base 800. Additionally, one or more vertical surfaces 944 of the corner shelves 926 of the wear runner 300 may contact one or more outer vertical surfaces 810 of the bosses 808 of the weld base 800.

In some embodiments, one or more of the upper surfaces 814 of the bosses 808 of the weld base 800 may be spaced from the bottom surface 806 of the wear runner 800. In some embodiments, the inner vertical surfaces 812 of the bosses 808 of the weld base 800 may be spaced from the vertical surfaces 918 of the rib 912 of the wear runner 900. These spaces may allow a user to observe abrasive wear before the weld base 800 or surface of the bucket are worn down. For example, a hole may form in the wear runner 900 between the top surface 904 and the bottom surface 906. Thus, when the user sees the hole, he or she may determine that the wear runner 900 needs to be replaced.

Therefore, in some embodiments the only contact surfaces between the weld base 800 and the wear runner 900 may be the lower surface 920 of the rib 912 of wear runner 900 contacting the top surface 804 of the weld base 800. The one or more vertical surfaces 944 of the corner shelves 926 of the wear runner 900 contacting the one or more outer vertical surfaces 810 of the bosses 808 of the weld base 800. In some embodiments, one or more horizontal lower surfaces 942 of the corner shelves 926 of the wear runner 900 may contact one or more of the corner portions 850 of the top surface 804 of the weld base 800. Thus, the outer portions of the wear runner 900 and weld base 800 provide sufficient contact and support to withstand abrasive wearing contact on the wear runner 300 from use of the bucket during use. The contact surfaces between the bosses 808 and the corner shelves 926 may bear loads in four directions: from side to side and from end to end in both directions. The contact surfaces between the rib 912 of the wear runner 900 and the top surface 804 of the weld base 800 may bear vertical or top loads. In some embodiments, the contact surfaces between the one or more horizontal lower surfaces 942 of the corner shelves 926 of the wear runner 900 and the one or more of the corner portions 850 of the top surface 804 of the weld base 800 may also bear vertical or top loads.

In some embodiments, the wear runner 900 may be placed on the weld base 800 such that the tabs 932 in the opening 902 of the wear runner 900 align with the tabs 816 in the opening 802 of the weld base 800. Thus, the top surfaces 818 of the tabs 816 of the weld base 800 may contact the bottom surfaces 940 of the tabs 932 of the wear runner 900. In some embodiments, the outer surfaces 820 of the tabs 816 of the weld base 800 may have the same curvature and length as the outer surfaces 938 of the tabs 932 of the wear runner 900 such that the outer surfaces 820, 938 form a single surface.

Channels 1044 may be formed between the tabs 932, 816. The channels 1044 may be sided to fit the lower flanges 1008 of the locking pin assembly 1000, as described in more detail below.

In some embodiments, the wear runner 900 may fit over the weld base 800 such that the wall 822 extends partially or completely down the height of the weld base 800. Thus, the top surface 904 and outer surface of the wall 922 may mostly cover the weld base 800, preventing material from contacting and wearing the weld base 800 during use of the bucket.

Step 506 includes inserting the locking pin assembly 1000 into the opening 902 of the wear runner 900. The locking pin assembly 1000 may be the locking pin assembly 1000 described in reference to FIGS. 10A-10B.

The locking pin assembly 1000 may be inserted with the top 1014 pointing upward. The pairs of upper flanges 1006 and lower flanges 1008 may be aligned with the channels 1044. Thus, the locking pin assembly 1000 may be pushed downward such that the lower flanges 1008 pass through the channels 1044 between the tabs 932 of the wear runner 900 then the tabs 816 of the weld base 800. In some embodiments, the upper flanges 1006 may not be capable of passing through the channels 1044. In other embodiments, the upper flanges 1006 may also be capable of passing through the channels 1044.

When the locking pin assembly 1000 is fully inserted in the aligned openings 802, 902, the lock 1004 may be aligned with the intersection between the tabs 816 of the weld base 800 and the tabs 932 of the wear runner 900. In other embodiments, the lock 1004 may be aligned with either the tabs 816 of the weld base 800 or the tabs 932 of the wear runner 900.

FIG. 11A illustrates a top view of the locking pin assembly 1000 inserted into the aligned openings 902, 802 of the wear runner 900 and weld base 800, according to one or more embodiments of the present disclosure.

Step 508 includes rotating the locking pin assembly 1000 to lock the wear runner 900 to the weld base 800. FIGS. 11B-11E illustrate the locking pin assembly 1000, weld base 800, and wear runner 900 in the locked position, according to one or more embodiments of the present disclosure. FIG. 11B illustrates a top view of the locking pin assembly 1000 locked in the aligned openings 902, 802 of the wear runner 900 and weld base 800. FIG. 11C illustrates a cross-section of the assembled wear runner assembly 700 through the 11C-11C line in FIG. 11B. FIG. 11D illustrates a cross-section of the assembled wear runner assembly 700 through the 11D-11D line in FIG. 7. FIG. 11E illustrates a zoomed-in view of the locking pin assembly 1000 disposed in the aligned openings 802, 902 of the weld base 800 and wear runner 900.

The locking pin assembly 1000 may be rotate in any suitable manner. In some embodiments, the user may use a tool to rotate the locking pin assembly 1000. For example, the user may use a tool such as a socket wrench to contact or grip the hexagonal outer surface 1030 of the tool engagement feature 1028 on the top 1012 of the pin 1002 to maneuver the locking pin assembly 1000.

The locking pin assembly 1000 may be rotated in either direction (clockwise or counter-clockwise). The locking pin assembly 1000 may be rotated until the lower flanges 1008 are disposed under the tabs 816 of the weld base 800 and the upper flanges 1006 are disposed over the tabs 932 of the wear runner 900.

During rotation, the locks 1036 of the locking tab 1024 contacts the outer surfaces 820, 938 of the weld base 800 and wear runner 900. The outer surfaces 820, 938 pushes against the locks 1036 as the locking pin assembly 1000 rotates, pushing the locks 1036 inward into the cavity 1038 in the shaft 1010 of the pin 1002. Once the upper flanges 1006 and lower flanges 1008 are aligned with the tabs 816, 932, the locks 1036 are pressed against the outer surfaces 820, 938 of the tabs 816, 932. The spring 1040 of the lock 1004 may press the locks 1036 outward against the outer surfaces 820, 938 creating friction therebetween. The force applied by the spring 1040 and the curvature of the outer surfaces 820, 938 may prevent the locking pin assembly 1000 from rotating in either direction. This may lock the locking pin assembly 1000 to the weld base 800 and wear runner 900, thereby locking the wear runner 900 to the weld base 800.

In the locked position, the top surfaces 1026 of the lower flanges 1008 contact the bottom surfaces 822 of the tabs 816 of the weld base 800 and the bottom surfaces 1020 of the upper flanges 1006 contact the top surfaces 936 of the tabs 932 in the wear runner 900. One or more of these contact surfaces between the locking pin assembly 1000 and the tabs 816 of the weld base 800 and the tabs 932 of the wear runner 900 may prevent movement of the wear runner 900 and locking pin assembly 1000 relative to the weld base 800. The contact surfaces may secure the wear runner 900 and locking pin assembly 1000 to the weld base 800 during use of the bucket. In particular, top surfaces 1026 of the lower flanges 1008 contact the bottom surfaces 822 of the tabs 816 of the weld base 800 to prevent lifting off of the locking pin assembly 1000. In some embodiments, the upper flanges 1006 and lower flanges 1008 of the locking pin assembly 1000 do not carry load, but serve to maintain the coupling between the wear runner 900 and weld base 800.

The locking pin assembly 1000 may be removed by rotating the locking pin assembly 1000 in either direction. The locking pin assembly 1000 is rotated until the lower flanges 1008 align with the channels 1044 between the tabs 816 of the weld base 800 and the tabs 932 of the wear runner 900. The locking pin assembly 1000 may then be pulled upward such that the lower flanges 1008 pass through the channels 1044. The user may insert a tool into the tool engagement feature 1028 of the locking pin assembly 1000 or under an upper flange 1006 or lower flange 1008 to pry the locking pin assembly 1000 out of the aligned openings 902, 802.

To remove the wear runner 900 from the weld base 800, step 504 may be performed in reverse. The user may insert a tool into the pry features 924 on the wall 922 of the wear runner 900 to pry the wear runner 900 off of the weld base 800.

Like the wear runner 300 and locking pin assembly 400 described in reference to FIGS. 1A-6E, the wear runner 900 and locking pin assembly 1000 described in reference to FIGS. 7-11E may be discarded. In some embodiments, the wear runner 900 and/or locking pin assembly 1000 may be reused on a different weld base 800. The locking pin assembly 1000 may be used in a different type of wear assembly such as a tooth and/or an adapter for a nose of the lip or a shroud for a lip of the bucket. In some embodiments, a new wear runner 900 and/or locking pin assembly 1000 may be secured to the same weld base 800. In some embodiments, the weld base 800 may also be replaced.

Like the weld base 200, wear runner 300, and pin 402 described in reference to FIGS. 1A-6E, the weld base 800, wear runner 900, and pin 1002 described in reference to FIGS. 7-11E may be formed of any suitable material, including a cast iron, steel, or other material.

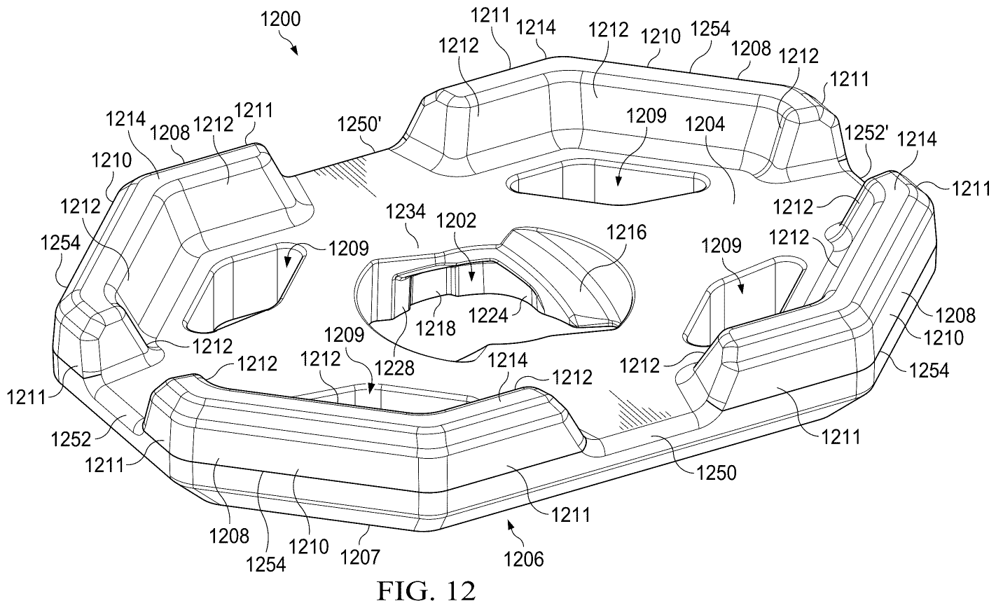

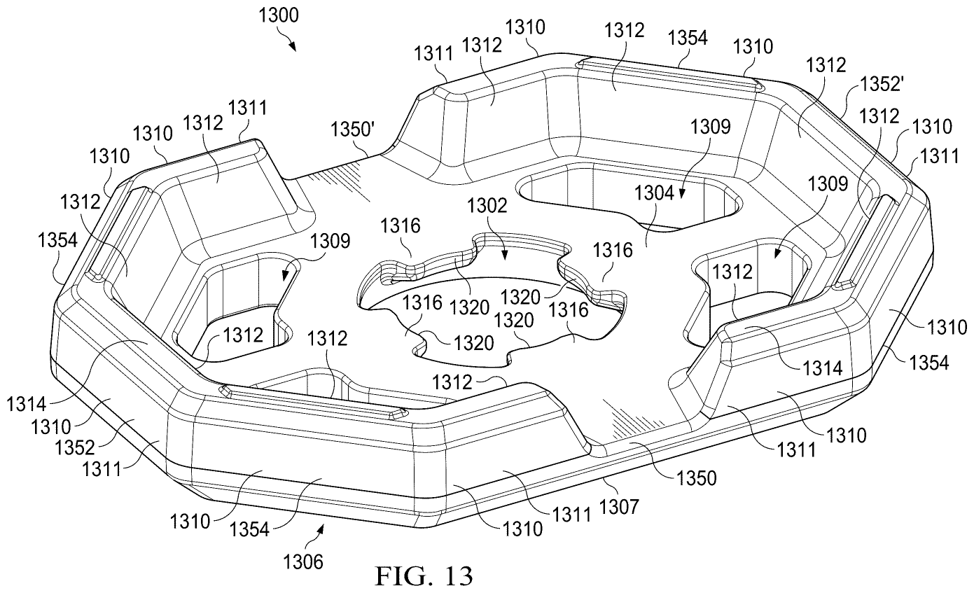

FIGS. 12-13 illustrate additional embodiments of weld bases for a wear runner assembly, according to one or more embodiments of the present disclosure. FIG. 12 illustrates an embodiment of a weld base 1200 that may be used in wear runner assembly with the wear runner 300 shown in FIGS. 3A-3F and the locking pin assembly 300 shown in FIGS. 4A-4F. FIG. 13 illustrates an embodiment of a weld base 1300 that may be used in wear runner assembly with the wear runner 900 shown in FIGS. 9A-9B and the locking pin assembly 1000 shown in FIGS. 10A-10B.

The weld base 1200 shown in FIG. 12 includes a top surface 1204 and a bottom surface 1206. An opening 1202 extends from the top surface 1204 to the bottom surface 1206. The opening 1202 may be disposed at a center of the weld base 1200. However, in other embodiments, the opening 1202 may be off-center.

The bottom of the weld base 1200 may include one or more weld grooves 1207 disposed around part or all of the perimeter of the weld base 1200. The weld grooves 1207 may be angled upward from the bottom surface 1206. The weld base 1200 may also include one or more apertures 1209 that extend from the top surface 1204 to the bottom surface 1206. The weld grooves 1207 and/or the apertures 1209 may allow the weld base 1200 to be welded to the surface of a bucket. The weld grooves 1207 and/or the apertures 1209 may also advantageously reduce the amount of material needed to form the weld base 1200 decreasing the weight and lowering the cost.

In some embodiments, the perimeter of the weld base 1200 may be octagonally shaped as shown in the illustrated embodiment. Thus, the weld base 1200 may include two opposing lateral sides 1250, 1250′, two opposing ends 1252, 1252′, and four diagonal sides 1254 extending between the lateral sides 1250, 1250′ and the ends 1252, 1252′. However, the weld base 1200 may be any suitable shape. For example, the weld base 1200 may be a rectangle, square, hexagon, circle, oval, or any other suitable shape. The weld base 1200 may also be symmetrical. For example, when viewed from the top, the weld base 1200 may be symmetrical along a horizontal axis and a vertical axis.

The weld base 1200 includes one or more bosses 1208 that project upwards from the top surface 1204. The bosses 1208 may extend along the sides and/or corners of the weld base 1200. For example, a boss 1208 may extend along a side of the weld base 1200. The boss 1208 may also extend through and past the corners defining that side. The bosses 1208 may also extend inward towards a center of the weld base 1200, as shown in the illustrated embodiment. In some embodiments, the bosses 1208 may be arranged around the outer portion of the top surface 1204 such that the bosses 1208 form an inner space in the weld base 1200.

In some embodiments, as shown in the illustrated embodiment, a first boss 1208 may extend from the lateral side 1250, along a diagonal side 1254, to the end 1252. A second boss 1208 may extend from the end 1252, along a diagonal side 1254, to the lateral side 1250′. A third boss 1208 may extend from the lateral side 1250′, along a diagonal side 1254, to the end 1252′. A fourth boss 1208 may extend from the end 1252′, along a diagonal side 1254, to the lateral side 1250. However, any number of bosses 1208 may extend along any combination of the sides 1250, 1250′, 1252, 1252′, 1254.

There may be any suitable number of bosses 1208 on the weld base 1200. For example, in the illustrated embodiment, the weld base 1200 may include four bosses 1208 that extend along four sides. However, the weld base 1200 may include 1, 2, 3, 5, 6, 7, 8, 9, or 10 bosses 1208.

The bosses 1208 include one or more outer vertical surfaces 1210 oriented outward from the center of the weld base 1200. These outer vertical surfaces 1210 may be disposed along part or all of the perimeter of the weld base 1200. The bosses 1208 also include one or more inner vertical surfaces 1212 oriented generally inward towards a center of the weld base 1200. The bosses 1208 also include an upper surface 1214. The upper surface 1214 of the bosses 1208 is raised with respect to the top surface 1204 of the weld base 1200. The intersection between the outer vertical surfaces 1210 and the upper surface 1214 and the inner vertical surfaces 1212 and the upper surface 1214 may be chamfered or rounded or curved such that the intersection is generally smooth.

The outer vertical surfaces 1210 of each boss 1208 may include one or more outer bearing surfaces 1211. In some cases, the outer bearing surfaces 1211 may be disposed along the lateral sides 1250, 1251′ and/or the ends 1252, 1252′. In some cases, the outer bearing surfaces 1211 may be disposed on the diagonal surfaces 1254. In some cases, all of the outer vertical surfaces 1210 are outer bearing surfaces 1211. However, any combination of outer vertical surfaces 1210 may be outer bearing surfaces 1211. These outer bearing surfaces 1211 may be configured to contact and/or bear against corresponding vertical surfaces on the wear runner. For example, when a wear runner such as the wear runner 300 shown in FIGS. 2A-2F is used, one or more outer bearing surfaces 1211 of the bosses 1208 of the weld base 1200 may contact and/or bear against one or more inner surfaces 325 of the wall 322 of the wear runner 300. When fully assembled, these bearing surfaces may loads from end-to-end, lateral-side-to-lateral-side and/or diagonal-side-to-diagonal-side.

The top surface 1204 of the weld base 1200 may be generally octagonal, as shown in the illustrated embodiment. The top surface 1204 may be configured to contact a corresponding horizontal surface on the wear runner, such as the lower surfaces 320 of the ribs 312, 312′ of the wear runner 300 shown in FIGS. 3A-3F. In other embodiments, the top surface 804 may be any suitable shape. For example, the top surface 804 may be rectangular, circular, ovular, T-shaped, L-shaped, V-shaped, or any other suitable shape.

The opening 1202 of the weld base 1200 may be similar to the opening 202 of the weld base 200 shown in FIGS. 2A-2D. Thus, the opening 1202 may be configured to fit and secure a locking pin assembly such as the locking pin assembly 400 shown in FIGS. 4A-4F. For example, the opening 1202 may include ramps 1216 along which the flanges 410 of the locking pin assembly 400 can move and/or slide. The opening 1202 may also include ridges 1228 and pockets 1218 for compressing and locking the locks 404 of the locking pin assembly 400. There may also be recesses 1224 next to the pockets 1218 and under the ramps 1216 that are configured to fit and/or prevent further movement of the respective flanges 410 of the locking pin assembly 400. A tab 1234 may be formed in the opening 1202 above a ridge 1228 and pocket 1218 for preventing upward movement of the respective flange 410 and locking the locking pin assembly 400 into opening 1202 of the weld base 1200. However, the opening 1202 may include any other parts and functionality of the opening 202 described above in reference to FIGS. 2A-2D or FIGS. 6A-6E.

In the embodiment illustrated in FIG. 13, the weld base 1300 includes a top surface 1304 and a bottom surface 1306. An opening 1302 extends from the top surface 1304 to the bottom surface 1306. The opening 1302 may be disposed at a center of the weld base 1300. However, in other embodiments, the opening 1302 may be off-center.

The bottom of the weld base 1300 may include one or more weld grooves 1307 disposed around part or all of the perimeter of the weld base 1300. The weld grooves 1307 may be angled upward from the bottom surface 1306. The weld base 1300 may also include one or more apertures 1309 that extend from the top surface 1304 to the bottom surface 1306. The weld grooves 1307 and/or the apertures 1309 may allow the weld base 1300 to be welded to the surface of a bucket. The weld grooves 1307 and/or the apertures 1309 may also advantageously reduce the amount of material needed to form the weld base 1300 decreasing the weight and lowering the cost.

In some embodiments, the perimeter of the weld base 1300 may be octagonally shaped as shown in the illustrated embodiment. Thus, the weld base 1300 may include two opposing lateral sides 1350, 1350′, two opposing ends 1352, 1352′, and four diagonal sides 1354 extending between the lateral sides 1350, 1350′ and the ends 1352, 1352′. However, the weld base 1200 may be any suitable shape. For example, the weld base 1300 may be a rectangle, square, hexagon, circle, oval, or any other suitable shape. The weld base 1300 may also be symmetrical. For example, when viewed from the top, the weld base 1300 may be symmetrical along a horizontal axis and a vertical axis.

The weld base 1300 includes one or more bosses 1308 that project upwards from the top surface 1304. The bosses 1308 may extend along the sides and/or corners of the weld base 1300. For example, a boss 1308 may extend along a side of the weld base 1300. The boss 1308 may also extend through and past the corners defining that side. The bosses 1308 may also extend inward towards a center of the weld base 1300, as shown in the illustrated embodiment. In some embodiments, the bosses 1308 may be arranged around the outer portion of the top surface 1304 such that the bosses 1308 form an inner space in the weld base 1300.

In some embodiments, as shown in the illustrated embodiment, a first boss 1308 may extend from the lateral side 1350, along a diagonal side 1354, along the end 1352, and along another diagonal side 1354 to the lateral side 1350′. A second boss 1308 may extend from the lateral side 1350′, along a diagonal side 1354, along the end 1352′, along another diagonal side 1354, to the lateral side 1350. Thus, in some embodiments, the bosses 1308 may be generally C-shaped. However, any number of bosses 1308 may extend along any combination of the sides 1350, 1350′, 1352, 1352′, 1354.

There may be any suitable number of bosses 1308 on the weld base 1300. For example, in the illustrated embodiment, the weld base 1300 may include two bosses 1308 that extend along four sides. However, the weld base 1300 may include 1, 2, 3, 5, 6, 7, 8, 9, or 10 bosses 1308.

The bosses 1308 include one or more outer vertical surfaces 1310 oriented outward from the center of the weld base 1300. These outer vertical surfaces 1310 may be disposed along part or all of the perimeter of the weld base 1300. The bosses 1308 also include one or more inner vertical surfaces 1312 oriented generally inward towards a center of the weld base 1300. The bosses 1308 also include an upper surface 1314. The upper surface 1314 of the bosses 1308 is raised with respect to the top surface 1304 of the weld base 1300. The intersection between the outer vertical surfaces 1310 and the upper surface 1314 and the inner vertical surfaces 1312 and the upper surface 1314 may be curved such that the intersection is generally smooth.

The outer vertical surfaces 1310 of each boss 1308 may include one or more outer bearing surfaces 1311. In some cases, the outer bearing surfaces 1311 may be disposed along the lateral sides 1350, 1351′ and/or the ends 1352, 1352′. In some cases, the outer bearing surfaces 1311 may be disposed on the diagonal surfaces 1354. In some cases, all of the outer vertical surfaces 1310 are outer bearing surfaces 1311. However, any combination of outer vertical surfaces 1310 may be outer bearing surfaces 1311. These outer bearing surfaces 1311 may be configured to contact and/or bear against corresponding vertical surfaces on the wear runner. For example, when a wear runner such as the wear runner 900 shown in FIGS. 9A-9B is used, one or more outer bearing surfaces 1311 of the bosses 1308 of the weld base 1300 may contact and/or bear against one or more inner surfaces 925 of the wall 922 of the wear runner 900. When fully assembled, these bearing surfaces may loads from end-to-end, lateral-side-to-lateral-side and/or diagonal-side-to-diagonal-side.

The top surface 1304 of the weld base 1300 may be generally octagonal, as shown in the illustrated embodiment. The top surface 1304 may be configured to contact a corresponding horizontal surface on the wear runner, such as the lower surface 920 of the rib 912 of the wear runner 300 shown in FIGS. 9A-9B. In other embodiments, the top surface 1304 may be any suitable shape. For example, the top surface 1304 may be rectangular, circular, ovular, T-shaped, L-shaped, V-shaped, or any other suitable shape.

The opening 1302 of the weld base 1300 may be similar to the opening 802 of the weld base 800 shown in FIGS. 8A-8B. Thus, the opening 1302 may be configured to fit and secure a locking pin assembly such as the locking pin assembly 1000 shown in FIGS. 10A-10B. For example, the opening 1302 may include one or more tabs 1316 under which a lower flange 1008 of a locking pin assembly 1000 may fit to prevent upward movement of the locking pin assembly 1000. The tabs 1316 may also include an outer surface 1320 that may be shaped (e.g. curved) for contacting a lock 1004 of the locking pin assembly 1000, thereby locking or securing the locking pin assembly 1000 within the opening 1302 of the weld base 1300. However, the opening 1302 may include any other parts and functionality of the opening 802 described above in reference to FIGS. 8A-8B or FIGS. 11A-11E.

Persons of ordinary skill in the art will appreciate that the implementations encompassed by the present disclosure are not limited to the particular exemplary implementations described above. In that regard, although illustrative implementations have been shown and described, a wide range of modification, change, combination, and substitution is contemplated in the foregoing disclosure. It is understood that such variations may be made to the foregoing without departing from the scope of the present disclosure. Accordingly, it is appropriate that the appended claims be construed broadly and in a manner consistent with the present disclosure.

What is claimed is:

1. A locking pin assembly comprising:
a pin, comprising:
a shaft; and
a first flange projecting outward from the shaft and comprising a first cavity; and
a lock disposed within the first cavity of the first flange, wherein the lock comprises:
a locking tab; and
a compressible foot,
wherein the compressible foot is disposed within the first cavity such that the locking tab extends outward from the first flange.

2. The locking pin assembly of claim 1, wherein the first flange further comprises top ramp.

3. The locking pin assembly of claim 2, wherein the first flange further comprises a bottom ramp.

4. The locking pin assembly of claim 1, further comprising a second flange projecting outward from the shaft and comprising a second cavity.

5. The locking pin assembly of claim 4, wherein the first and the second flanges extend only partially circumferentially about the shaft, and second flange is disposed on the shaft opposite the first flange.

6. The locking pin assembly of claim 1, wherein the pin further comprises a head disposed at a top of the shaft.

7. The locking pin assembly of claim 6, wherein a diameter of the head is larger than a diameter of the shaft.

8. The locking pin assembly of claim 6, wherein the head comprises a tool engagement feature, wherein the tool engagement feature is sunken with respect to a top surface of the head.

9. The locking pin assembly of claim 1, further comprising a second flange and a third flange.

10. The locking pin assembly of claim 9, further comprising a fourth flange, wherein the first flange, the second flange, the third flange, and the fourth flange each comprise the same structure.

11. A locking pin assembly comprising:
a pin, comprising:
a shaft comprising a cavity;
a first upper flange projecting outward from a top portion of the shaft; and
a first lower flange projecting outward from a bottom portion of the shaft; and
a lock disposed within the cavity.

12. The locking pin assembly of claim 11, wherein the pin further comprises a second upper flange radially spaced from and axially aligned with the first upper flange.

13. The locking pin assembly of claim 11, wherein the pin further comprises a second lower flange radially spaced from and axially aligned with the first lower flange.

14. The locking pin assembly of claim 11, wherein the lock is radially aligned with and axially spaced from the first upper flange and the first lower flange.

15. The locking pin assembly of claim 11, wherein the lock comprises:
a locking tab; and
a biasing mechanism coupled to the locking tab,
wherein the biasing mechanism biases the locking tab outward from the cavity.

16. A locking pin assembly for connecting a wear member to a base, comprising:
a pin, comprising:
a shaft;
a plurality of first flanges radially disposed and projecting outward from a top portion of the shaft, the plurality of first flanges each having downward facing surfaces shaped to engage with the wear member; and
a plurality of second flanges radially disposed and projecting outward from a bottom portion of the shaft; the plurality of second flanges each having a upward facing surfaces shaped to engage with the base, the downward facing surfaces of the plurality of first flanges being aligned with the upward facing surfaces of the plurality of second flanges.

17. The locking pin assembly of claim 16, wherein the shaft comprises a cavity, and wherein the locking pin assembly comprises a lock disposed in the cavity.

18. The locking pin assembly claim 17, wherein the lock is radially aligned with and axially spaced between one of the plurality of first flanges and one of the plurality of second flanges.

19. The locking pin assembly of claim 16, wherein the lock extends from opposing sides of the shaft.

20. The locking pin assembly of claim 16, comprising a biasing mechanism that biases engagement portions of the lock outward from the cavity.
